(19) United States
(12) Patent Application Publication
(10) Pub. No.: US 2026/0346567 A1
(43) Pub. Date: Nov. 5, 2026

(54) METHOD FOR PRODUCING A MULTILAYER BODY, MULTILAYER BODY, OUTER-LAYER COMPOSITE, AND USE OF AN OUTER-LAYER COMPOSITE FOR PRODUCING A MULTILAYER BODY

(71) Applicant: OVD Kinegram AG, Zug (CH)

(72) Inventors: René STAUB, Zug (CH); Lucas ZORTEA, Zug (CH); Manuel KOECHLIN, Zug (CH)

(21) Appl. No.: 19/462,011

(22) Filed: Jan. 28, 2026

(30) Foreign Application Priority Data
Feb. 5, 2025 (DE) 10 2025 104 195.4

(51) Int. Cl. B32B 3/30; B32B 7/08; B32B 7/12; B32B 27/08; B32B 27/36; B32B 37/10

(52) U.S. Cl. CPC B32B 3/30; B32B 7/08; B32B 7/12; B32B 27/08; B32B 27/365; B32B 37/10; B32B 2307/7376; B32B 2551/00

(57) ABSTRACT

A method for producing a multilayer body (1), wherein, when a structure layer (2) having a surface relief (21) is pressed together with an outer layer (3) and a layered entity (4), the structure layer (2) is pressed at least into the outer layer (3) such that the surface relief (21) is at least partially exposed in a depression (5) in the multilayer body (1).

### BACKGROUND OF THE INVENTION

The invention relates to a method for producing a multilayer body, to a multilayer body, to an outer-layer composite for producing a multilayer body, and to the use of an outer-layer composite for producing a multilayer body.

It is known for multilayer bodies such as security documents to be furnished with exposed surface structures (relief structures) in order to increase protection against forgery. Such relief structures may have tactile or optical (scattering, refractive or diffractive) functions and may be designed as pictorial, periodic or stochastic microstructures or macrostructures.

Various methods for generating such surface structures are known. In the case of fused laminates such as security documents consisting of polycarbonate (PC) or other thermoplastically deformable materials, the relief structures are commonly generated during the laminating process. To achieve this, the various layers of a plastics stack are fused between heated pressing plates which are themselves furnished with a surface structure for the purpose of generating the relief structure, such that the surface structure of the pressing plate is transferred to the surfaces of the laminate and the corresponding relief structure is formed. Document EP 1629994 A2 mentions typical process conditions for the lamination, which may be performed for example in two stages, in a heat press and a cold press. In this case, in the heat press, lamination is performed at typically 200 N/cm² to 300 N/cm² and over 100 °C to 200 °C, and in the cold press, lamination is performed at 200 N/cm² to 550 N/cm² and at a cooling temperature of at most 50 °C (the temperature in the cold press should be at most 50 °C). Various embodiments for the surface structuring of the pressing plates are also mentioned. Said pressing plates may have recesses or elevations and may have different shapes (for example selected individually or in combination from the group comprising circular, parabolic, rectangular, V-shaped, trapezoidal). The structures may preferably be lenticular, with grid spacings of 100 μm to 300 μm and structure heights of 2 μm to 150 μm. It is also described that a diffractive structure may be arranged on an elevated structure in the pressing plate. The diffractive structure is thus introduced into the laminate surface in a recessed configuration and can thus be protected against mechanical action.

A disadvantage of this method is that, owing to the process conditions, the pressing plates are subject to a high level of wear and must be replaced at regular intervals, which involves great effort and high costs. Furthermore, owing to the high viscosity of the thermoplastic, structurally accurate moldings are difficult to implement below a certain dimension threshold. It is not possible or is possible only with very high pressure and high temperatures, for such high-quality and fine surface structures (structure heights up to approximately 10 μm) to be stamped into card laminates by means of such pressing plates. The high thermal and mechanical load during the lamination process however increases the risk of degradation of embedded security features, for example of a KINEGRAM®. Further components such as RFID elements can also be damaged by the high loads. The integration of fine surface reliefs, for example of microlenses having a short focal length or diffractive elements, is therefore at least made very difficult. Furthermore, it is difficult here to maintain narrow vertical and lateral tolerances with respect to features in underlying layers, and to achieve an in-register arrangement of corresponding layers.

Furthermore, fine structures in particular are sensitive to abrasion on the surface of the multilayer body. Existing solutions for improving scratch resistance are based for example on a hardened layer on the surface, which, however, then in turn makes it more difficult to introduce the structures during the laminating operation.

It is also known for films having pre-structured layers to be adhesively bonded onto security documents. For example, it is known to use a transfer film which contains a structure layer, structured on both sides, on a detachable carrier film. This can be used to apply the structure layer to the surface of the multilayer body. A disadvantage of this method is that it is not possible to integrate structure layers into the multilayer body over a partial area without generating edges or other elevations on the surface of the multilayer body, which in turn give rise to increased wear as a result of abrasion.

### SUMMARY OF THE INVENTION

It is therefore an object of the present invention to provide an improved method for producing a multilayer body, in particular a security document, preferably in the form of a laminate, and to provide an improved multilayer body, in particular an improved security document, preferably in the form of a laminate.

The object is achieved by means of a method according to the present invention. The method is in particular a laminating method. A multilayer body, in particular a security document, preferably in the form of a laminate, is produced by means of the method.

The method comprises the following steps:
a) providing an outer layer;
b) providing a structure layer having a surface relief, wherein the surface relief forms a surface, averted from the outer layer, of the structure layer;
c) providing a layered entity comprising at least one layer;
d) pressing the structure layer, the outer layer and the layered entity together in order to laminate the structure layer, the outer layer and the layered entity, wherein the structure layer is more dimensionally stable than the outer layer,
wherein the outer layer, the structure layer and the layered entity are fixedly interconnected as a result of the pressing-together operation, and the following step takes place during the pressing-together operation:
d1) pressing the structure layer into the outer layer, or into the outer layer and the layered entity, in such a way that the structure layer forms a depression into the outer layer, or into the outer layer and the layered entity, and the structure layer is fixedly arranged in said depression, and that the surface relief of the structure layer at least partially forms an exposed outer surface of the obtained multilayer body, in particular security document.

One or more of steps a), b), c) and d) are preferably carried out in the stated sequence. The steps a) to c) preferably start before step d) and/or in succession and/or are carried out simultaneously before step d). Step d1) is in particular a sub-step of step d), and preferably takes place simultaneously with step d) or simultaneously with a time period of step d).

The object is also achieved by means of a multilayer body according to the present invention. The multilayer body is in particular a security document. The multilayer body is preferably produced by means of the method according to the invention. The multilayer body comprises a layered entity having at least one layer, an outer layer arranged on the layered entity, and a structure layer having a surface relief. The structure layer has been pressed into the outer layer such that the structure layer has been fixedly arranged in a depression of the outer layer or in a depression of the outer layer and of the layered entity. The surface relief of the structure layer at least partially forms an exposed outer surface of the multilayer body.

The object is also achieved by means of an outer-layer composite according to the present invention for producing a multilayer body.

The outer-layer composite is in particular designed so as to be suitable for producing the multilayer body according to the invention, and/or is used in the method according to the invention for producing the multilayer body. The outer-layer composite has an outer layer and a structure layer, wherein the structure layer has a surface relief on a side averted from the outer layer and, in particular under lamination conditions, is more dimensionally stable than the outer layer such that the outer layer can be laminated together with a layered entity to form the multilayer body, wherein the surface relief can be pressed into the outer layer such that the structure layer can be arranged in a depression of the outer layer and an exposed outer surface of the multilayer body can be at least partially formed by the surface relief.

The object is also achieved by the use of the outer-layer composite according to the present invention for producing a multilayer body. The multilayer body is in particular the multilayer body according to the invention, and/or has been or is produced by means of the method according to the invention. Preferably, the outer layer is provided and the structure layer is provided by virtue of the outer-layer composite being provided.

Thus, when it is provided, the structure layer may in particular be provided separately from the outer layer and applied to the outer layer, or advantageously may have already been applied to the outer layer as part of the outer-layer composite. In particular, in both cases, the structure layer already bears the surface relief before the pressing-together operation.

Through the provision of the structure layer which already has the surface relief during the pressing-together operation, it is achieved that, during the production of the multilayer body, in particular of the security document in the form of a laminate, there is no need for a pressing plate to have a corresponding surface structure for introducing the surface relief, and at the same time there is no need for the surface relief to be introduced or applied retroactively. It is advantageously thus possible to dispense with the use of pressing plates having an elaborate surface structure, and/or the production of the pressing plates can at least be simplified.

Furthermore, since the structure layer is situated at least partially in the depression, improved protection of the surface relief against abrasion is achieved. This is because the maximum height of the surface relief can thus be at least partially aligned with the surface of the outer layer. Proceeding from a surface, formed by the outer layer, of the multilayer body, it is thus the case that edges and/or tips of the surface relief, which are mentioned by way of example, are less exposed and are thus abraded less during use. It is also thus possible for the structure layer to be integrated into the multilayer body with improved adhesion. Thus, for example in relation to retroactively applied structure layers, conditions are established which make it more difficult for the structure layer to be detached, and protection against forgery is thus also improved. At the same time, deformations of the structure layer and of the surface relief can be minimized or avoided. It is also possible that, during the pressing-together operation, the structure layer, the outer layer and the layered entity are connected in a single process. This constitutes an advantage in particular in relation to the retroactive application of surface reliefs.

A further advantage of the invention is that the design possibilities for the optical effect and for the structure geometry of the surface relief are improved, because the structure layer is not part of the outer layer(s), which has/have been optimized for the formation of the rest of the outer surface of the multilayer body. It is thus possible for the material of the structure layer to be optimized to a greater degree for the optical effect of the surface relief, and for the material of the outer layer(s) to be optimized for example for a protective function.

This can in particular also be achieved by virtue of the outer-layer composite according to the invention, having the outer layer and the structure layer with the surface relief, being provided already before the pressing-together operation, in particular before the laminating operation. The outer-layer composite also makes it possible for the structure layer to be provided in a system which, in a manner that is particularly independent of the design of the rest of the layered entity, already ensures that the structure layer is adequately embedded into the depression in the outer layer. It is also hereby possible for such a system to initially be stored and transported, and thus for example applied for the first time at the location of manufacture of the multilayer body, for example in the form of a security document already containing, or not yet containing, personalized information items. This can also increase protection against forgery, because the tools and steps for creating the surface relief are no longer accessible at the location of manufacture.

A further advantage of the outer-layer composite is that it is possible to achieve particularly good in-register positioning of the surface relief in the multilayer body, in particular relative to further optical features of the multilayer body, in particular of the outer layer. It is possible here to maintain a particularly narrow tolerance, because the positioning of the structure layer and thus the positioning of the surface relief are separate from the pressing-together process. For example, a degree of play of pressing tools by which the pressing-together operation is performed thus has no adverse effect on the position of the surface relief.

Advantageous refinements of the invention are indicated in the dependent claims.

In particular, the multilayer body according to the invention is produced by means of the method according to the invention. The method according to the invention is thus preferably carried out so as to obtain the multilayer body according to the invention.

The outer-layer composite is preferably made part of the multilayer body by means of the method and/or by the use of said outer-layer composite.

The multilayer body, in particular the security document, is preferably a laminate. A laminate is to be understood in particular to be a multilayer entity of which at least two layers are cohesively interconnected, in particular welded together, by the action of pressure and temperature. For example, a laminate is or has been produced by means of a laminating process. The pressing-together operation is therefore in particular a laminating operation, preferably with the outer layer being welded together with the layered entity and optionally further layers of the layered entity. During the welding operation, in particular, a supply of heat and an exertion of pressure have the effect that the corresponding layers are plasticized at least at surfaces to be connected, and are fused together there, such that a fixed connection is present there after cooling. In the multilayer body, therefore, preferably at least the outer layer and the layered entity have been welded.

A security document may be understood here to mean a preliminary product, in particular a “blank”, without personalized information items, or to mean a finished security document containing personalized information items. The security document may thus in particular constitute a main body which can optionally also be furnished with security features or personalized information items. For example, the preliminary product may have all security features aside from the personalized information items. The multilayer body is however preferably not a preliminary product in the sense of a transfer film or a laminating film, which is itself provided for being applied once again to a main body.

A layer or ply is preferably to be understood to mean a substantially planar entity. A layer or ply may itself be of single-layer or multilayer form. A layer or ply may be formed by a self-supporting film, or may not exhibit self-supporting properties. In particular, the multilayer body comprises a plurality of layers, which are arranged one above the other in a sectional view. It is also possible for a layer or ply to be present over a full area or in parts, in particular in the form of a pattern, in particular as seen in a plan view. The expressions “pattern” or “in the form of a pattern” are to be understood for example to mean patterns having geometrical shapes selected individually or in combination from the group comprising dots, lines, guilloche, image, symbol, logo, emblem, portrait, alphanumeric character, QR code, barcode. A pattern may be present in the form of a single image and/or in the form of an endless pattern.

A sectional view is directed in particular in a viewing direction along or parallel to a main plane of the multilayer body. A main plane is to be understood in particular to mean a plane which is spanned by the multilayer body, or by a layer thereof, when the thickness of the multilayer body or of the particular layer or ply is disregarded. A main plane may be understood in particular to mean a plane which extends along the width and the length of the multilayer body, wherein the width and the length of the multilayer body are greater than the thickness, that is to say in particular the depth, of the multilayer body. A plan view is in particular a view directed perpendicularly onto the main plane.

Register, or register accuracy, is to be understood to mean a positional accuracy of two or more layers relative to one another. Here, the register accuracy should lie within a predefined tolerance, and be as close as possible. At the same time, the register accuracy of a plurality of layers relative to one another is an important feature for increasing process reliability. Accurate positioning is carried out here in particular by means of register marks that are detectable by sensor means, preferably optically. These register marks may either be special separate elements or regions or layers, or may themselves be part of the elements or regions or layers to be positioned. Thus, when the structure layer, the outer layer and the layered entity are provided, one or more register marks are preferably detected in order to achieve in-register positioning of the surface relief relative to the outer layer and/or relative to the layered entity, in particular relative to one or more optical features, and/or regions provided for these, of the outer layer and/or of the layered entity.

Preferably, the structure layer and/or the surface relief has been or is provided only in parts, in particular in the form of a pattern, on the outer layer.

For example, the contour of the structure layer as seen in a plan view or top view may have a geometrical shape selected individually or in combination from: circle, ellipse, square, rectangle, triangle, image, symbol, logo, emblem, portrait, alphanumeric character.

It is also possible for holes or openings to be formed in the structure layer. It is also possible for shapes having high length-to-width ratios (>1:10), for example lines or curves, to be formed. In particular, in other words and preferably as seen in a plan view of the structure layer, a length of the structure layer can be measured in one direction, said length being at least ten times a width measured perpendicularly to the direction of the length. The smallest dimension of a geometrical shape is preferably more than 1 mm.

The surface relief of the structure layer preferably forms optically variable structures. Optically variable structures are to be understood in particular to mean structures selected individually or in combination from: diffractive surface relief, holographic surface relief, first-order diffraction grating, zeroth-order diffraction grating, blaze grating, achromatic surface relief, surface relief in the form of a lens and/or a lens array, an arrangement of micromirrors, microprisms, microlenses, microfacets, freeform surface, mirror surface, matte structure, in particular isotropic or anisotropic matte structure. The surface relief particularly preferably forms microlenses, in particular a microlens array. The surface relief more preferably forms convex and/or concave microlenses, which are in particular spherical or cylindrical.

The surface relief has in particular one or more structure elements. The surface relief preferably has a multiplicity of structure elements which periodically repeat, in particular in at least one direction or in two non-parallel directions. In other words, in particular, the structure elements on the surface preferably form either a one-dimensional or a two-dimensional grating, wherein, in particular, the one-dimensional grating is defined by a single direction vector and a single grating period, and, preferably, the two-dimensional grating is defined by two linearly independent direction vectors and two grating periods, which may differ. A two-dimensional grating arrangement may in particular be square, rectangular or hexagonal. For example, a structure element is a cylindrical or spherical microlens of a microlens array, a cylindrical lens of a sequence of cylindrical lenses, or a step of a blaze grating.

In the multilayer body, optical effects of the surface relief may be present independently or in interaction with underlying optical features, that is to say optical features situated further to the inside of the multilayer body. In particular, these optical features may be formed by one or more layers of the outer layer and/or of the layered entity and/or of an insert element which comprises the structure layer and one or more of the aforementioned layers. For example, periodic arrangements of microlenses may be utilized to generate variable personalized information items, so-called flip images (MLI/CLI) (MLI=multiple laser image; CLI=changeable laser image). It is however also possible to provide novel optical effects in interaction with underlying optical features embedded in the multilayer body, in particular optically variable features, for example a KINEGRAM®, in order to preferably further increase protection against forgery. In particular, in the multilayer body, there may be optical interaction between the surface relief and one or more further optical elements.

It is thus preferable for the surface relief to provide an optically variable effect and/or to be part of a security element having an optically variable effect. An optically variable effect is in particular an effect which exhibits different colors and/or shapes depending on a viewing angle. An optically variable effect may in particular be selected individually or in combination from: viewing-angle-dependent color change, viewing-angle-dependent contrast change, viewing-angle-dependent motif change, holographic image, cinematographic image. A viewer can vary the viewing angle at which the multilayer body is viewed, in particular by tilting and/or rotating and/or bending same.

For example, the optical interaction may consist in that the surface relief forms microlenses which are arranged so as to render visible to a viewer a motif which is made up of elements of microimages, said elements being visible through the microlenses. Said motif is in particular visible at a defined viewing angle, and, preferably, a movement and/or a transformation of the motif is visible as a result of a change in viewing angle. It is furthermore preferable if, at another viewing angle, the motif is not visible.

The multilayer body is in particular not limited to a single surface relief. In addition to the surface relief, it is optionally possible for one or more further surface reliefs to be present, which preferably have been or are provided and/or formed by means of the structure layer or by means of one or more further structure layers.

It is also conceivable for two outer layers and in particular at least two structure layers to be provided, wherein, for each outer layer of the two outer layers, a surface relief of a structure layer is arranged on a side averted from the particular outer layer.

The multilayer body can thus be produced so as to have at least one external surface relief on both sides, in particular without the use of structured pressing plates in the pressing-together operation.

It is particularly preferable if the surface relief of the multilayer body has a maximum structure height of less than 20 μm, preferably of less than 10 μm, and/or a maximum structure width of less than 40 μm, preferably of less than 25 μm. As already mentioned above, in particular, the advantage is achieved that it is possible to avoid the high pressures and temperatures that would be required to produce such surface reliefs using surface-structured pressing plates, and therefore degradation of the multilayer body can be avoided. Particularly fine surface reliefs can thus be generated.

The outer layer has been or is formed in particular as a carrier layer. In particular, the structure layer has been or is applied to the outer layer, preferably by means of one of the following methods or combinations thereof: adhesive bonding, stamping, hot stamping using a hot stamping film, cold stamping using a cold stamping film, and/or lacquering.

In steps a) and b), the outer layer and the structure layer are preferably provided in the form of the outer-layer composite. The properties specified for the outer layer and the structure layer are thus in particular applicable analogously to outer-layer composite, and vice versa.

In particular, the pressing-together operation is carried out by means of at least one pressing tool which has a pressing surface of preferably planar form. In particular, the pressing surface of the pressing tool may be formed without any surface relief. This applies in particular at least to the pressing surface in those regions which are intended for pressing in the structure layer. Other customary shape configurations of a pressing tool are in particular also possible here. Preferably, in other words, at least that part of the pressing surface which exerts pressure on the structure layer during the pressing-together operation is planar. During the pressing-together operation, in particular laminating operation, the pressing tool is in particular nevertheless in direct contact with the surface relief of the structure layer, expediently such that, by means of the pressing surface, a force or a pressure is exerted on the structure layer, in particular on the surface relief, and the structure layer is thus advantageously impressed into the outer layer and optionally the layered entity so as to form the depression. In particular, therefore, the pressing surface is planar, or at least a pressing surface region via which the force is exerted on the structure layer is planar.

The pressing-together operation expediently takes place at least in a heat press of a laminating device. The pressing surface is preferably comprised by a pressing plate of a laminating device, in particular by a pressing plate in a heat press of a laminating device. Preferably, two pressing plates of a laminating press, between which the pressing-together operation and the pressing-in operation are performed, each have such a pressing surface.

It is also possible that, after the pressing-together operation in the heat press, cooling and/or pressing is subsequently carried out in a cooling press of the laminating device. In particular, the multilayer body, preferably the security document, is hereby obtained in the form of the laminate.

It is preferable for all pressing surfaces of all pressing tools used in a laminating device employed for laminating the multilayer body to be designed correspondingly to the described pressing surface. It is advantageously thus possible for elaborate custom manufacture of pressing tools or pressing surfaces to be dispensed with entirely, or to be simplified.

It is preferable if the structure layer comprises or consists of a thermoset and/or comprises or consists of an elastomer.

Thermosets are in particular polymers which are no longer deformable after hardening or cross-linking, that is to say preferably in the hardened or cross-linked state. In particular, they can no longer be deformed by heating or other measures. In particular, thermosets cross-link such that heating-induced softening is prevented. In the hardened state, thermosets can typically be machined substantially only by cutting processes. Thermosets consist preferably of hard, amorphous and non-soluble polymers which in particular are cross-linked by means of covalent bonds, expediently are cross-linked in a closely meshed configuration. Before hardening, the starting materials are referred to in particular as precursors or prepolymers. These precursors are generally oligomers or monomer resins, which are converted by chemical reactions (for example polymerization) to form cross-linked thermosets. Thermosets preferably have a cross-link density of more than 10, preferably more than 25, cross-links per 1000 polymer backbones. In particular, here, the cross-links are formed by covalent bonds. Thermosets are preferably selected individually or in combination from: polyacrylates, polyurethanes, polyester resins, epoxy resins, melamine resins, silicones.

Elastomers are in particular polymers which are preferably characterized by their high elasticity and flexibility. Elastomers consist of preferably long polymer chains which are cross-linked by covalent bonds or physical interactions, or have such polymer chains. Elastomers typically have a cross-link density of more than 0 to 10 cross-links per 1000 polymer backbones. Elastomers are in particular cross-linked such that, preferably under normal conditions, they are elastically deformable and can thus, for example, assume their original shape again after expansion or compression. Elastomers are preferably not to be understood as encompassing so-called thermoplastic elastomers. Elastomers are preferably soluble, in particular soluble in the associated monomer, and/or fusible. Soluble preferably also encompasses swellable.

Preferred elastomers are silicones.

Such a cross-link density of a thermoset or elastomer expediently exists under normal conditions, that is to say in particular at a temperature of 20 °C and a pressure of 101.325 kPa.

The structure layer preferably has a modulus of elasticity of greater than 3 MPa, preferably greater than 5 MPa, preferably greater than 15 MPa. The modulus of elasticity is preferably determined in accordance with DIN EN ISO 527-3:2003-07 (“Plastics—determination of tensile properties—part 3: test conditions for films and sheets”—publication date: 2003-07), preferably at a temperature of 25 °C. The determination of the modulus of elasticity, in particular of the modulus of elasticity under tension, is performed here using film test strips by means of a tensile testing machine, for example a tensile testing machine from ZwickRoell GmbH & Co. KG, Ulm, Germany. The width of the film strip is preferably 15 mm+/−0.1 mm, and the length of the film strip is preferably 100 mm+/−0.5 mm or preferably 50 mm+/−0.5 mm for film materials exhibiting in particular high elongation. The test speed for a film length of 100 mm is 10 mm/min+/−1 mm/min, or the test speed for a film length of 50 mm is 5 mm/min+/−1 mm/min.

Alternatively or in addition, the structure layer has in particular a Shore A hardness of greater than 30, preferably greater than 50, and/or a Shore D hardness of greater than 40, preferably greater than 60. The hardness is measured in particular under normal conditions.

A structure layer having a Shore D hardness of over 60 and a modulus of elasticity of over 15 MPa is particularly preferable. It is thus possible in particular to achieve particularly low deformation of the structure layer as a result of the pressing-together operation, that is to say it is possible to achieve a particularly good structure preservation coefficient SPC, as will be described further below.

The structure layer has in particular a thinnest point with a thickness of at least 1 μm or more, in particular at least 5 μm, preferably at least 10 μm, and/or a thickest point with a maximum thickness of at most 150 μm or less, in particular at most 100 μm. The thickness is preferably measured in a sectional view.

Advantageously, the structure layer is substantially transparent, or is transparent. Aside from the effect based on the structuring, said structure layer may however have further properties, for example coloration with a colorant in the visible range (VIS) or a UV-fluorescent dye. These additional properties can serve in particular as a further security or identification feature.

The structure layer is preferably part of an insert element, which in particular is arranged on the outer layer of the outer-layer composite and can be provided in this form preferably before the pressing-together operation. In addition to the insert element, further insert elements may also be provided. It is preferable for a plurality of insert elements, in particular a multiplicity of insert elements, to be arranged on an outer layer provided for multiple blanks. A blank corresponds in particular to a region provided for a single end product, for example a single security document. The insert element is or the insert elements are preferably provided in parts, in particular in the form of a pattern, on the outer layer.

For example, the contour of the insert element as seen in a plan view or top view may have a geometrical shape selected individually or in combination from: circle, ellipse, square, rectangle, triangle, image, symbol, logo, emblem, portrait, alphanumeric character.

It is also possible for holes or openings to be formed in the insert element. It is also possible for shapes having high length-to-width ratios (>1:10), for example lines or curves, to be formed. The smallest dimension of a geometrical shape is preferably more than 1 mm.

It is possible for the structure layer to be furnished, in particular on a side facing toward the outer layer and/or the layered entity, with one or more further layers which, together with the structure layer, preferably from the insert element. In particular, the structure layer has been or is furnished with one or more of the following layers, preferably in the stated sequence proceeding from the structure layer: a buffer layer, in particular a PC film or a PET film, a color layer, or a further structured layer, a hot-sealing adhesive layer. The color layer or the further structured layer is or comprises, in particular, a color print layer.

For example, the following layer sequences are preferred:
structure layer, PC film;
structure layer, PET film, hot-sealing adhesive;
structure layer, PET film, color print layer, hot-sealing adhesive.

It is also possible for the further structured layer to contain or form, for example, a Kinegram®.

It is also possible for one or more further layers, such as one or more adhesion promoter layers, to be provided between said layers. For example, the buffer layer or the outer layer may have been furnished with adhesion promoter layers on both sides. It is advantageously possible, for example, for the buffer layer to have been furnished with an adhesion promoter layer on each side, and thus in particular for the adhesion of the structure layer to the outer layer, and therefore in particular in the multilayer body, to be increased or improved.

In particular, the outer layer comprises or consists of a thermoplastic, in particular an amorphous thermoplastic. It is also possible for the outer layer to comprise or consist of a plurality of thermoplastics, in particular amorphous thermoplastics. The outer layer preferably comprises or consists of polycarbonate (PC), polyvinyl chloride (PVC) or acrylonitrile butadiene styrene copolymer (ABS), or mixtures thereof.

Thermoplastics are to be understood in particular to mean plastics materials which can be reversibly deformed, in particular reversibly thermoplastically deformed, in a particular temperature range. By cooling and reheating into the molten state, solidification and deformation of a thermoplastic can thus be repeated for as long as thermal decomposition of the material does not occur as a result of overheating. It is in this aspect that thermoplastics differ in particular from thermosets and elastomers. A further property is in particular the weldability of thermoplastics. The outer layer advantageously thus allows reliable lamination together with the layered entity. In particular, the outer layer has been or is directly welded to the layered entity, expediently by means of the laminating operation.

The outer layer has in particular a softening temperature of 50 °C to 200 °C, preferably of 80 °C to 180 °C, particularly preferably of 120 °C to 170 °C. The softening temperature is in particular measured in accordance with VICAT B 50.

The layered entity preferably comprises at least one layer which faces toward the outer layer and which comprises a thermoplastic which is weldable or welded, and/or is welded during the pressing-together operation, to the outer layer. It is also possible for the layered entity to have one or more further layers comprising one or more thermoplastics which are weldable to one another, and which in particular are welded during the pressing-together operation. For example, the outer layer, that layer of the layered entity which faces toward the outer layer, and preferably also the optional further layers, comprise or consist of polycarbonate. In particular, the outer layer together with the structure layer thus forms a covering layer for a card core that is formed by the layered entity.

The layered entity may also have one or more of the following elements or a combination thereof:
an optical security element, for example a hologram or a Kinegram®, micromirror or a matte structure;
a printed layer having UV-fluorescent ink, a printed layer for example for forms for information items, such as “Surname”, “Date of birth”, etc.;
a printed layer for personalized information items such as Surname and Date of birth etc.;
a doped absorption layer for the inscription of information items, in particular of personalized information items, by laser action;
an adhesion promoter layer, a partial release layer for impeding release attempts.

The layered entity and/or in particular at least that layer of the layered entity which faces toward the outer layer preferably has a softening temperature of 50 °C to 200 °C, more preferably of 80 °C bis 180 °C, particularly preferably of 120 °C to 170 °C, in particular measured in accordance with VICAT B 50.

It is advantageously possible for the multilayer body to have a structure preservation coefficient SPC of greater than 0.5, in particular greater than 0.8, preferably greater than 0.95. The SPC is calculated as follows:

$$S P C = \frac{H 2 S 1}{H 1 S 2}$$

Here, H1 is the height of a structure element, and S1 is the width of a structure element, for example the diameter of a concave or a convex lens, of the surface relief before the pressing-together operation. H2 is the height of a structure element, and S2 is the width of a structure element, for example the diameter of a concave or a convex lens, of the surface relief after the pressing-together operation, that is to say in particular in the obtained multilayer body.

In the case of symmetrical structure elements, for example spherical or cylindrical lenses, S1 may be defined as the width of a convex structure element at 5%, and/or of a concave structure element at 95%, of its height H1. S2 can be defined in the same way. Here, the height of 0% is defined in particular by a plane, facing toward the outer layer, of the structure element, and/or the height of 100% is defined on the exposed outer side of the surface relief. “At 5% of the height” means in particular that, in the case of a convex structure element, the width is measured at a measurement height of the structure element, which measurement height amounts to 5% of the structure height, in particular of the maximum structure height, proceeding from that side of the structure element which faces toward the outer layer, wherein, preferably, the width relates to a raised portion formed by the convex structure element. “At 95% of the height” means in particular that, in the case of a concave structure element, the width is measured at a measurement height of the structure element, which measurement height amounts to 95% of the structure height, in particular of the maximum structure height, proceeding from that side of the structure element which faces toward the outer layer, wherein, preferably, the width relates to a depression formed by the concave structure element.

In the case of very fine or asymmetrical structures, for example diffractive structures, or else in the case of stochastic structures, for example matte structures, in which the width of a structure element is difficult to measure or cannot be measured reliably, it is for example possible to take only H1 or only H2 into account. These values may be determined for example as a mean modulation depth or averaged roughness values Ra. In these cases, the SPC is calculated as follows:

$$S P C = \frac{H 2}{H 1}$$

The smaller H2 and the greater S2, the lower the SPC. Correspondingly, values of the SPC are categorized in particular as follows:
SPC>0.95 very good structure preservation
SPC>0.80 good structure preservation
SPC>0.50 moderate structure preservation
SPC<0.5 normally no longer usable.

In particular, the multilayer body has a height alignment coefficient HAC of greater than 0.8, in particular greater than 0.9, preferably greater than 0.95. The HAC is calculated as follows:

$$H A C = \frac{D max - D 1}{D max}$$

Here, Dmax is the maximum thickness of the structure layer after the pressing-together operation or the maximum thickness of an insert element, wherein, in particular, the structure element is present as a part in the insert element. In particular, therefore, the maximum thickness is the spacing of the highest points of the surface relief from the outer layer, preferably measured along a surface normal to a main plane of the multilayer body.

D1 is the protruding thickness D1 of the structure layer. The protruding thickness D1 corresponds in particular to the spacing between a reference plane, which is spanned by the outer layer outside the depression, and an outer structure layer plane, which runs through a maximum or through a plurality of maxima of the structure layer and runs parallel to the reference plane. Here, the maximum or the maxima are in particular at a maximum distance from the interior of the multilayer body. The reference plane is preferably spanned by a height of the surface of the outer layer, which is present predominantly, that is to say in particular over more than 50% of the area, outside the structure layer. In particular, warped portions and/or elevations of relatively small area and similar local raised portions are thus preferably disregarded for the definition of the reference plane. The two planes are preferably substantially parallel. In particular, the spacing is measured along a surface normal to said planes, and/or the spacing constitutes the shortest distance between the two planes.

If a plurality of different values are available for Dmax, the highest value is preferably taken into account. If a plurality of different values are available for D1, in particular per structure element, the highest value is preferably taken into account.

Alternatively or in addition, the multilayer body has a subsidence coefficient SC of greater than 0.8, in particular greater than 0.9, preferably greater than 0.95. The SC is calculated as follows:

$$S C = \frac{D 2}{D max}$$

Dmax is the maximum thickness of the structure layer after the pressing-together operation or of the insert element after the pressing-together operation. D2 is the depth of the depression, in particular of the depression in the outer layer or in the outer layer and the layered entity, preferably measured after the structure layer or an insert element comprising the structure layer has been detached. If a plurality of different values are available for D2, the highest value is preferably taken into account.

If there are a plurality of structure layers and/or insert elements in the multilayer body, it is preferable for at least one of said structure layers and/or insert elements to have such a height alignment coefficient HAC and/or subsidence coefficient SC.

It is preferably possible for the HAC and/or the SC to be at most 1. Higher values are however also conceivable.

Laminations of asymmetrical layered entities consisting of plies of different materials can lead to curved surfaces of the resulting multilayer body. The curvature is attributable in particular to different thermal expansion behaviors of the individual plies. Since the described layered entity is typically asymmetrical, curved surfaces are present in particular in the region of the structure layer and/or of the insert element.

In the region of the structure layer and/or of the insert element, the surface of the multilayer body has in particular only regions with a mean curvature radius of greater than 0.5 m, wherein such a region preferably has a smallest dimension of greater than 1 mm in each case, more preferably has a smallest dimension of greater than 3 mm in each case. The smaller the curvature radius, the more pronounced the surface curvature can be, in particular when viewed in the presence of certain light reflections/patterns. “In the region of the structure layer and/or of the insert element” is to be understood in particular to mean a region which, preferably as seen in a plan view, overlaps the structure layer and/or the insert element, and the region boundaries of which are spanned by external boundaries of the structure layer and/or of the insert element.

The curvature or the curvature radius may be determined in a coordinate system having an x axis and a y axis perpendicular to said x axis, wherein the multilayer body extends with its length along the x axis and with its width along the y axis. For example, a curvature radius Rx of a surface profile, measured along the x axis, and a curvature radius Ry of a surface profile, measured along the y axis, may be determined. Here, curvatures of Rx<0.5 m and Ry<0.5 m are commonly very clearly visible; curvatures of Rx in a range from 0.5 m to 1 m and Ry in a range from 0.5 m to 1 m are commonly clearly visible; curvatures of Rx in a range from 1 m to 2 m and Ry in a range from 1 m to 2 m are only faintly visible, and curvatures of Rx>2 m and Ry>2 m are faintly visible to not visible.

The curvature or the curvature radii may be derived in particular from a surface measurement determined for example using a white light interferometer, in particular the model VK-X3000 from Keyence (company headquarters: Bedrijvenlaan 5, 2800 Mechelen, Belgium). Here, in particular, the surface profile of a rear side and/or of a front side of the multilayer body is captured. It is hereby possible in particular to determine the curvature radii Rx and Ry on the mutually perpendicular axes x and y. The rear side is to be understood here in particular to mean a side, which is averted from the structure layer, of the multilayer body. The front side is preferably to be understood to mean a side, which has the structure layer, of the multilayer body.

The curvature radius is preferably measured on the rear side because a surface relief can make a curvature measurement more difficult. The curvature radius is preferably measured in the center of the structure layer and/or of the insert element. Alternatively or in addition, the curvature radius is measured over a region in which the change in the height owing to the curvature is 5 times greater, more preferably 10 times greater, than the modulation depth of surface structures or any dirt or defects.

The determination of the curvature radius is preferably based on a measurement region which has a dimension amounting to at most one third of the dimension, in the same direction, of the region covered by the structure layer, and which expediently contains the center of area, in particular as seen in a plan view, of the latter region. The measurement region is thus preferably a portion of the region covered by the structure layer, and is not situated at the edge, in particular is situated at a moderate distance from the edge, of said region. More preferably, those dimensions of the measurement region along which the curvature radii are determined are preferably greater than 3 mm.

The curvature radius is preferably determined as the radius of a fitted ideal circular arc over the measurement region. In particular, the mean curvature radius is thus determined over a measurement region of preferably 3 mm in size.

Outliers, for example owing to dirt, or instances of intentional tampering of the surface profile, for example by means of surface reliefs, are thus preferably disregarded for the determination of the curvature radius.

The structure layer, and optionally the structure layer together with further parts of the insert element, preferably exhibits adhesion of GT 0 or GT 1 or an intermediate level between these characteristic values, and/or of 4B or 5B or an intermediate level between these characteristic values, on the outer layer, in particular in the multilayer body. This adhesion is determined in particular by means of a cross-cut test, preferably in accordance with DIN EN ISO 2409:2013-06 (“Paints and varnishes-Cross-cut test (ISO 2409:2013); German version EN ISO 2409:2013”, German title: “Beschichtungsstoffe—Gitterschnittprüfung (ISO 2409:2013); Deutsche Fassung EN ISO 2409:2013”, publication date: 2023-06), or by means of ASTM D 3359-09, Test Method B.

Preferably, in the cross-cut test, a blade and preferably a template is used to make six cuts vertically and six cuts horizontally (at an angle of 90° with respect to the vertical cuts) into the coating as far as the substrate, that is to say in particular as far as the layered entity or as far as an underlying surface on which the multilayer body is situated. The cut width is dependent on the layer thickness of the structure layer and/or of the insert element. In the case of a layer thickness of less than 60 μm, the spacing of the cuts is preferably approximately 1 mm.

A clear adhesive tape or a fabric adhesive tape having an adhesive force of 2.3 N/cm to 4.3 N/cm is adhered to the resulting square of the cuts (measurement surface). Said tape was peeled off in a time of 0.5 s to 1 s at an angle of 60°.

The evaluation is performed by visual assessment of the measurement surface and classification into cross-cut characteristic values, in accordance with DIN EN ISO 2409:2013-06, of 0 (very good adhesive strength) to 5 (very poor adhesive strength), abbreviated to GT 0 to GT 5, or in accordance with ASTM D 3359-09, Test Method B, of 5B (very good adhesive strength) to OB (very poor adhesive strength).

The criteria for classification into the corresponding characteristic values are summarized in the following table, with the surfaces obtained by the cross-cut test being schematically illustrated in FIGS. 6a to 6d.

TABLE 1
Criteria for classification of the cross-cut adhesive strength into
characteristic values, in particular in accordance with DIN EN ISO
2409:2013-06 and ASTM D3359-09. The surfaces
obtained are schematically illustrated in FIGS. 6a to 6d.

| | | Characteristic | Characteristic |
|---|---|---|---|
| Description | Surface | value ISO | value ASTM |
| The cut edges are completely | — | GT 0 | 5B |
| smooth; no portion of the | | | |
| structure layer or of the insert | | | |
| element has broken off. | | | |
| Small splinters of the structure | see FIG. 6a | GT 1 | 4B |
| layer or of the insert element | | | |
| have broken off at the | | | |
| intersection points of the grid | | | |
| lines; broken-off area | | | |
| approximately 5% of the | | | |
| portions. | | | |
| The structure layer or the insert | see FIG. 6b | GT 2 | 3B |
| element has broken off along | | | |
| the cut edges and/or at the | | | |
| intersection points of the grid | | | |
| lines; broken-off area | | | |
| approximately 15% of the | | | |
| portions. | | | |
| The structure layer or the insert | see FIG. 6c | GT 3 | 2B |
| element has partially or | | | |
| completely broken off in broad | | | |
| strips along the cut edges, | | | |
| and/or the structure layer or the | | | |
| insert element has completely or | | | |
| partially broken off from | | | |
| individual portions; broken-off | | | |
| area approximately 35% of the | | | |
| portions. | | | |
| The structure layer or the insert | see FIG. 6d | GT 4 | 1B |
| element has broken off in broad | | | |
| strips along the cut edges and/or | | | |
| has completely or partially | | | |
| broken off from individual | | | |
| portions; broken-off area | | | |
| approximately 65% of the | | | |
| portions. | | | |
| Broken-off area more than 65% | — | GT 5 | 0B |
| of the portions. | | | |

It is advantageously also possible that the multilayer body passes the bending test for ID-1 cards, in particular in accordance with ISO 24789-2:2024-01. In addition to the standard criterion for passing the test (no card cracks), it is possible that the structure layer does not exhibit any detachment from the rest of the multilayer body.

In particular, during the pressing-together operation, a temperature is reached, preferably a lamination temperature is reached, which lies at least 5 °C above, preferably at least 10 °C above, more preferably at least 15 °C above, the softening temperature of the outer layer. As the softening temperature, use is made here of preferably the VICAT softening temperature T_{VST} (Vicat softening temperature VST/A/120=T_{VST}) and/or preferably the softening temperature in accordance with the VICAT A 120 and/or A 50 and/or B 50 and/or B 120 method. If a plurality of VICAT softening temperatures can be determined, the higher value is preferably used here. For polycarbonate (PC) with a softening temperature in accordance with the B 50 method of 145 °C, then for example at least 150 °C or more is selected as a lamination. The lamination temperature may be measured in particular at the pressing surface and/or the outer layer. Preferably, the temperature that is reached during the pressing-together operation is maintained for at least 2 minutes, preferably at least 5 minutes, preferably at least 10 minutes.

It is thus ensured in particular that the outer layer, which is thermoplastic, becomes sufficiently soft, and that the structure layer is pressed into the outer layer to a sufficient penetration depth.

In particular, during the pressing-together operation, a pressure in particular of 0.2 MPa or more, in particular of 0.3 MPa or more, preferably of 0.5 MPa or more, more preferably of at least 1.2 MPa, is generated. This pressure is exerted in particular by the pressing surface on at least the structure layer and the outer layer.

In the case of an outer layer comprising PC and a layered entity comprising PC, it is preferable to provide a lamination temperature that is 15 °C above the softening temperature of the outer layer, for a duration of at least 13 minutes and with a generated pressure of 1.2 MPa.

Furthermore, for lamination of the provided structure layer, covering layer and layered entity, a sequence having one or more of the following steps is possible:
heating the pressing tool, in particular the pressing plates of the heat press, and in particular the provided structure layer, covering layer and layered entity, wherein preferably no pressure, or a pressure of less than 0.005 MPa, is exerted on the structure layer, the covering layer and the layered entity by the pressing tool;
performing a pressing-together operation during step d) in the heat press, wherein, in particular, the pressure exerted on the structure layer, the covering layer and the layered entity by means of the pressing plates, and/or the temperature, is increased, preferably increased gradually and/or in stepped fashion, in particular such that, in each of a plurality of substeps, a defined constant pressure is exerted, and a constant temperature is held, over a defined period of time (holding times or plateaus), and, between the holding times, a defined pressure increase and/or temperature increase takes place over a defined period of time (ramps), wherein said pressure increase and/or temperature increase may in particular be linear or approximately linear. It is thus preferably the case that, in each sub-step, a defined constant pressure is held for a specific holding time, that is to say in particular the pressure is held at a plateau for the duration of the holding time, and, between the sub-steps, a defined pressure adjustment is carried out over a defined period of time, that is to say in particular a pressure adjustment is carried out in the form of a ramp over the duration of the defined period of time. For example, for this purpose, at least one or more sub-steps may be carried out as plateaus, and sub-steps situated between plateaus may be carried out as ramps with linear pressure increases. In particular, step d) comprises the following steps:
ST1) performing a pressing-together operation with an exerted pressure p1, at a temperature T1, for a holding time t1,
ST12) performing a pressing-together operation for a ramp time t12, with a preferably linear rate of change of pressure (p2−p1)/t12 and with a preferably linear rate of change of temperature (T2−T1)/t12, where p1 and p2 denote the start and the end pressure, and T1 and T2 denote the start and the end temperature, of the sub-step.
ST2) performing a pressing-together operation with an exerted pressure p2, at a temperature T2, for a holding time t2.

In more general terms, the method may comprise in particular one or more step sequences i each having a sequence of different steps of the pressing-together operation STi, STi(i+1) and ST(i+1), where i is a natural number. The step sequences i preferably begin in succession in accordance with their number value i, that is to say the step sequence 2 begins for example after the step sequence 1. The step sequence 1 comprises for example the steps ST1, ST12 and ST2. For i≥2, the first step STi of a step sequence i under consideration in particular also constitutes the final step of a preceding step sequence i−1. For example, the step sequence 2 thus in particular comprises the steps ST2, ST23 and ST3, wherein the step ST2 is the final step of the step sequence 1.

A step STi takes place in particular with the pressure pi, at the temperature Ti, for the holding time ti. The step ST(i+1) takes place in particular with the pressure p(i+1), at the temperature T(i+1), for the holding time t(i+1). The step STi(i+1) takes place in particular between the step STi and the step ST(i+1) and preferably over a ramp time ti(i+1) with a preferably linear rate of change of pressure for the change in the pressure from the value pi to the value p(i+1) and preferably with an in particular linear rate of change of temperature for the change of the temperature from the value Ti to the value T(i+1). The variable i ranges in particular from 1 to an end value n−1, where n is preferably the number of steps in which, in particular, the pressure is held at a holding pressure for a defined period of time (that is to say preferably is held at a plateau for said period of time). In the case of an end value of n=2, for example, the steps ST1, ST12 and ST2 are thus carried out in succession. It is also possible for the end value n to have the value 3, 4 or 5. Other values are also conceivable depending on the materials and requirements.

The following preferably applies:
p(i+1)>pi and in particular T(i+1)<Ti or T(i+1)≤Ti.

The following more preferably applies:
p(i+1)≥pi+0.2 MPa, preferably p(i+1)≥pi+0.3 MPa.

The temperature that is reached in the steps STi is preferably kept substantially constant, for example at 170 °C. Such sub-steps are preferably carried out for the purposes of laminating the outer layer comprising or consisting of PC together with at least one layer comprising or consisting of PC in the layered entity, said at least one layer facing the outer layer. A PC card is preferably thus produced.

It is advantageously possible by means of corresponding sub-steps (plateaus and ramps), or by gradually increasing and holding the pressure and the temperature over a defined period of time, to achieve improved pressing of the structure layer into the outer layer, such that the surface relief and the outer layer adhere well to one another and are minimally or not impaired by the pressing-together operation, and distortion of the multilayer body and instances of irregular material displacement can be reduced or avoided.

It is also possible that the following step is carried out after the pressing-together operation:
e) cooling the structure layer, the covering layer and the layered entity in a cooling press.

The cooling in the cooling press preferably takes place at a pressure in a range from 0.1 MPa to 0.15 MPa.

A typical process of laminating an outer layer comprising PC and a layered entity comprising PC takes place in a laminating device, for example as summarized by the following table.

In this case, preferably oil-filled pressing blocks of the heat press are preheated to a temperature of 170 °C before the laminating operation. The heating and in particular cooling can be very inert.

| | Starting | | | |
|---|---|---|---|---|
| | pressure | | | |
| | or holding | Final | | |
| | pressure | pressure | Temperature | Duration |
| Step | [MPa] | [MPa] | [°C]* | [min] |
| ST1 | 0 or <0.005 | | 170 | 4 |
| ST12 | 0 or <0.005 | 0.15 | | 0.05 or <0.05 |
| ST2 | 0.15 | — | 170 | 0.05 or <0.05 |
| ST23 | 0.15 | 0.5 | | 1 |
| ST3 | 0.5 | — | 170 | 1 |
| ST34 | 0.5 | 0.8 | 170 | 2 |
| ST4 | 0.8 | — | 170 | 3 |
| ST45 | 0.8 | 1.2 | 170 | 2 |
| ST5 | 1.2 | — | 170 | 4 |

*Nominal temperature of the pressing blocks

Here, the value n is for example thus 5.

In a cold press (that is to say in particular between two pressing blocks at room temperature), the following step may for example be carried out:

| | Holding pressure | Final pressure | Temperature | Duration |
|---|---|---|---|---|
| Step | [MPa] | [MPa] | [°C]* | [min] |
| ST6 | 0.14 | — | <50 °C | 5 |

*Nominal temperature of the pressing blocks

It is possible that, preferably for the production of the structure layer before steps b) and d) and/or for the production of the outer-layer composite, the structure layer has been or is cross-linked. In particular, the structure layer has been or is thermally cross-linked and/or chemically cross-linked and/or cross-linked by means of electromagnetic radiation.

Chemical cross-linking preferably takes place through the mixing of two or more, in particular reactive, components. A wavelength by means of which the structure layer can be hardened by means of electromagnetic radiation and/or by means of which the structure layer is hardened for the purposes of cross-linking preferably lies in a range from 250 nm to 450 nm.

The cross-linking preferably refers to curing. In particular, the cross-linking, preferably curing, forms a three-dimensional network of cross-linked polymer chains.

In particular, during the curing, existing and/or previously formed polymer chains are cross-linked.

It is advantageous if the structure layer has already fully hardened and/or fully cross-linked before the pressing-together operation. It is thus possible for an adequately high force to be exerted on the structure layer in order to press this into the outer layer, without the surface relief being excessively deformed. Fully hardened and/or fully cross-linked is preferably to be understood to mean that more than 90% of the cross-linkable polymer constituents of the structure layer have been cross-linked. A fully hardened structure layer exists in particular when complete (>90%) cross-linking of its polymer constituents has taken place.

Preferably, in an edge region of the structure layer, the surface relief has been integrated form-fittingly or is integrable form-fittingly into the multilayer body. For this purpose, the surface relief preferably has been or is designed, in the edge region, for form-fitting connection to one or more layers of the multilayer body, in particular to the outer layer and/or to the layered entity. Preferably, therefore, the surface relief has been or is form-fittingly connected, in the edge region, to one or more layers of the multilayer body, in particular to the outer layer, during the pressing-together operation.

It is expedient that, in the edge region, the surface relief has one or more depressions which have been or are at least partially filled with material of the one or more layers of the multilayer body, in particular of the outer layer.

It is also conceivable that the material is alternatively or additionally formed at least in part by the layered entity.

Preferably, during the pressing-together operation, the one or more depressions of the surface relief in the edge region are filled with material of the outer layer, and/or form-fitting connection of the structure layer and outer layer, in particular interlocking of the structure layer with the outer layer and/or wedging of the structure layer with the outer layer, is carried out. In particular, in the edge region, the surface relief is designed such that, during the pressing-together operation, the material of the one or more layers of the multilayer body, in particular of the outer layer, can be pressed into the one or more depressions of the structure layer.

The edge region preferably comprises at least one structure period of the surface relief, in which the one or more depressions have been at least partially filled with the material and/or into which the material is at least partially pressed. The edge region preferably comprises two or more structure periods, in which the one or more depressions have been filled with the material and/or into which the material is at least partially pressed. It is also possible that, in the edge region, at least one, preferably exactly two or at least two, structure periods are predominantly or entirely covered by the material. Here, “predominantly” means in particular that more than 90% of the area which has the surface relief of the structure layer as seen in a plan view is covered.

It is possible that the surface relief is of the same design in the edge region as it is in adjacent regions which are situated in particular further toward the inside as seen in a plan view. That is to say, in this case, the same type of surface structure may be present in the edge region and in the interior of the surface relief. It is however also possible that, in the edge region, the surface relief has a structure which differs from the rest of the surface relief, preferably in order to optimize the edge region for the form-fitting integration and in order to optimize the interior for the optical effect.

The edge region may comprise the entire edge of the structure layer or only a part thereof or multiple parts thereof.

For the outer-layer composite, it is advantageously possible that the outer layer and the structure layer are configured such that, in particular at a temperature of more than 100 °C and/or in a range from 100 °C to 200 °C, the structure layer can be pressed into the outer layer by a pressure exerted on the structure layer in the direction of the outer layer.

If the outer layer consists of PC or if the outer layer comprises PC, then the structure layer is advantageously configured such that, in particular at a temperature of more than 150 °C and/or in a range from 150 °C to 200 °C, said structure layer can be pressed into the outer layer by a pressure of in particular more than 0.2 MPa exerted on the structure layer in the direction of the outer layer.

It is furthermore expedient if the outer layer, in particular the outer layer of the outer-layer composite, has been furnished with at least one adhesion promoter layer on a side facing toward or averted from the structure layer, or on each of two opposite sides. The adhesion to the structure layer and/or to the layered entity can thus be optimized, in particular such that the materials of the structure layer and of the layered entity can be further optimized for their respectively different main functions.

It is possible that the outer layer has a layer thickness which at least corresponds to or is greater than the layer thickness of the structure layer. The advantage can thus be achieved that the layers of the layered entity can be chosen particularly freely, and the outer-layer composite having such layer thickness relationships can be used for lamination with different layered entities, and in the process a sufficiently deep depression, or a high height alignment coefficient HAC or subsidence coefficient SC, is always ensured.

The outer-layer composite according to the invention preferably has the surface relief having structure dimensions adapted to the structure preservation coefficient SPC. The surface relief of the outer-layer composite preferably has structure dimensions which differ from, in particular are greater than, the structure dimension of the intended application in the finished multilayer body. For example, if the surface relief is present in the form of lenses, preferably microlenses, the focal length can be adapted to or optimized for the finished multilayer body after the pressing-together operation. In an insert element having a color layer, in particular a color print layer, which is arranged closer to the outer layer proceeding from the structure layer, the microlenses are preferably dimensioned such that their focal point does not coincide with the color print layer, in particular before the pressing-together operation, but does coincide therewith after the pressing-together operation. In this optional embodiment, it is thus in particular the case that the focal point is directed onto the color layer only after the pressing-together operation.

It is possible that the outer-layer composite is produced by virtue of one or more insert elements, in particular the multiplicity of insert elements, being provided on a film and being transferred from said film to the outer layer. Here, the outer layer is preferably self-supporting. The film may be a transfer film, preferably a hot stamping film or a cold stamping film, wherein the insert elements are transferred, as a transfer ply of the transfer film, said transfer ply being detachable from a carrier ply, or as part of such a transfer ply, to the outer layer. It is however also possible for the film to be a laminating film, such that the insert elements are transferred, as film elements of the laminating film, to the outer layer. For this purpose, the laminating film may for example have or be furnished with predetermined breaking points, such as cutouts, which are preferably produced by punching or lasering and which determine the shape of the transferred insert elements. The structure layer preferably already has the surface relief in the transfer film or the laminating film.

It is also conceivable for the structure layer and/or one or more insert elements to be applied, preferably directly applied, from a transfer film, preferably a hot stamping film or a cold stamping film, or from a laminating film, to a layer stack comprising the outer layer and the layered entity. The surface relief is preferably only subsequently generated in the structure layer.

The surface relief may in particular be produced by virtue of a master structure being provided which has a structure complementary to the surface relief. Said master structure is then expediently brought into contact with the structure layer such that the surface relief is predefined by the master structure. For this purpose, the structure layer and the master structure may be pressed against one another, and in the process, in particular, the structure layer may be cross-linked, preferably cross-linked by means of UV radiation. Here, the structure layer may already be present on the outer layer and optionally the layered entity, or else on a carrier ply of a transfer film or a laminating film.

In particular, the surface relief may also be produced on the carrier ply of a transfer film by virtue of the carrier ply being furnished or provided with a master structure. The structure layer is then expediently applied to said master structure such that the surface relief is predefined by the master structure. To transfer the structure layer to the outer layer, it is then possible for the carrier ply together with the master structure to be detached from the transfer ply with the structure layer, and optionally for one or more further layers, for example, in the case of hot stamping, a corresponding hot-sealing adhesive layer for connecting the transfer ply to the outer layer, or in the case of cold stamping, a corresponding adhesion-promoting UV print layer for connecting the transfer ply to the outer layer, to be detached. The outer-layer composite can thus be obtained, and/or the outer layer together with the structure layer can be provided before the pressing-together operation, in particular laminating operation.

### BRIEF DESCRIPTION OF THE DRAWINGS

The invention will be discussed by way of example below on the basis of a plurality of exemplary embodiments and with reference to the appended drawings, in which:

FIGS. 1a, 1b and 1c schematically show a method for producing the multilayer body so as to obtain the multilayer body,

FIG. 2 schematically shows dimensions of a structure element of the surface relief for the determination of the structure preservation coefficient SPC,

FIGS. 3, 4a and 4b schematically show dimensions of an exemplary structure element of the surface relief for the determination of the height alignment coefficient HAC and of the depth of a depression in the multilayer body,

FIG. 5 schematically shows an example of a curved multilayer body,

FIGS. 6a, 6b, 6c and 6d schematically show results of cross-cut tests for classification of the adhesive strength into characteristic values,

FIGS. 7-9 are schematic illustrations of exemplary multilayer bodies,

FIG. 10 schematically shows an example of a form-fittingly embedded structure layer in a multilayer body.

### DETAILED DESCRIPTION

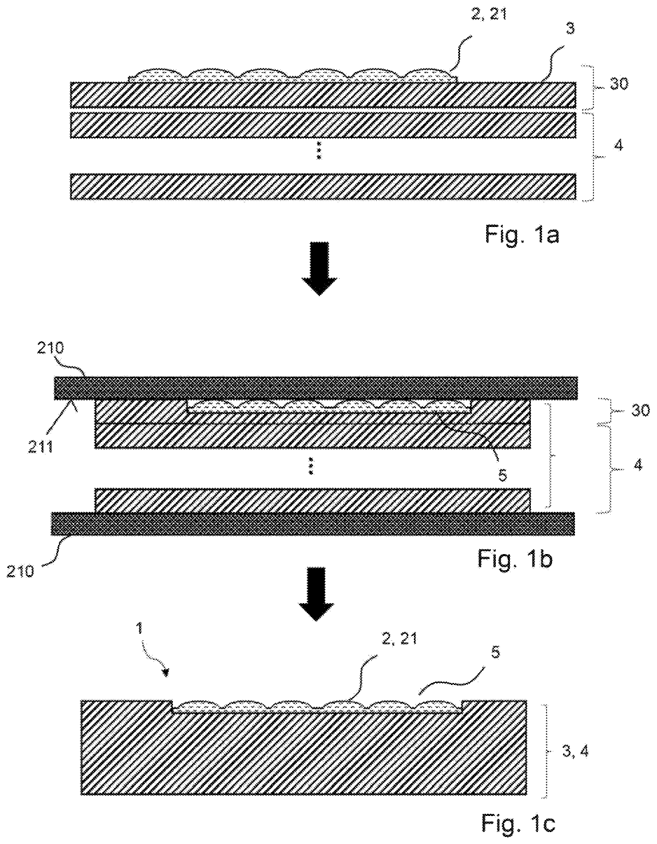

FIGS. 1a to 1c schematically illustrate a method for producing a multilayer body 1.

FIGS. 1a to 1c schematically show provided layers and tools, and the multilayer body 1, in a sectional illustration. The obtained multilayer body 1, which is illustrated in particular by FIG. 1c, is preferably a security document in the form of a laminate. The method for producing the multilayer body 1 comprises the following steps:
a) Providing an outer layer 3.
b) Providing a structure layer 2 having a surface relief 21. Here, the surface relief 21 forms a surface, averted from the outer layer 3, of the structure layer 2.
c) Providing a layered entity 4 comprising at least one layer. As illustrated by FIG. 1a, the layered entity may also have a plurality of layers.

Steps a) to c) are illustrated in particular by FIG. 1a.
d) Pressing the structure layer 2, the outer layer 3 and the layered entity 4 together in order to laminate the structure layer 2, the outer layer 3 and the layered entity 4.

The outer layer 3, the structure layer 2 and the layered entity 4 are fixedly interconnected as a result of the pressing-together operation. Here, the structure layer 2 is preferably more dimensionally stable than the outer layer 3.

Furthermore, the following step is carried out during the pressing-together operation, as is illustrated in particular by FIG. 1b and can also be seen in the multilayer body 1 in FIG. 1c:
d1) Pressing the structure layer 2 into the outer layer 3, or into the outer layer 3 and the layered entity 4. The pressing-in is performed such that the structure layer 2 forms a depression 5 into the outer layer 3, and the structure layer 2 is fixedly arranged in said depression 5. As can be seen in FIG. 1b, the structure layer 2 is preferably thus pressed at least into the structure layer 2, wherein the depression 5 may at least partially also be molded in the layered entity 4. The surface relief 21 of the structure layer 2 at least partially forms an exposed outer surface of the obtained multilayer body 1, as illustrated in particular by FIG. 1c.

Steps a) and b) may in particular take place simultaneously through the provision of an outer-layer composite 30 for producing the multilayer body 1. The outer-layer composite 30 may thus be employed for use in the above method. For this purpose, in particular upon or before the provision in steps a) and b), the outer-layer composite 30 has the outer layer 3 and the structure layer 2, wherein the structure layer 2 has the surface relief 21 on a side averted from the outer layer 3 and is more dimensionally stable than the outer layer 3 such that the outer layer 3 can be laminated together with a layered entity 4 to form the multilayer body 1, wherein the surface relief 21 can be pressed into the outer layer 3 such that the structure layer 2 can be arranged in the depression 5 of the outer layer 3 and an exposed outer surface of the multilayer body 1 can be at least partially formed by the surface relief 21.

As an alternative to the use of the outer-layer composite 30, it is however also possible for the outer layer 3 and the structure layer 2 to be provided separately, or for the structure layer 2 to be applied directly to a provided layer stack comprising the outer layer 3 and the layered entity 4. For example, it is thus possible for the outer layer 3 and the layered entity 4 to be provided first, as shown in FIG. 1a, without the outer-layer composite 30 being formed, and for the surface structure 2 having the surface relief 21 to be formed thereon.

As is also illustrated in particular by FIG. 1b, the pressing-together operation is performed by means of a pressing tool 210. Said pressing tool has a pressing surface 211. In particular, the pressing tool 210 comes into direct contact, by way of the pressing surface 211, with the surface relief 21 of the structure layer 2 during the pressing-together operation, such that a force is exerted on the structure layer 2 by means of the pressing surface 211. This force makes it possible in particular for the structure layer 2 to be pressed into the depression 5. For this purpose, the pressing tool 210 is preferably heated, and a sufficient pressure is exerted on the structure layer 2 by means of the pressing surface, such that the outer layer 3 is softened, whereas the structure layer 2 is softened to a lesser extent or is not softened. The pressing surface 211 is accordingly subjected to the temperature and the pressure, and therefore a particularly high level of wear can occur. It is therefore advantageous for the pressing surface 211 to have no surface relief and to be planar, because such easily producible pressing tools can for example be replaced inexpensively in relation to pressing tools having specially structured pressing surfaces.

In particular, the pressing surface 211 is comprised by a pressing plate of a laminating device, in particular by a pressing plate in a heat press of a laminating device. The pressing-together operation is thus preferably carried out in a heat press of a laminating device. The pressing-together operation may additionally take place in particular in a cooling press. In particular, the structure layer 2 has been or is cross-linked, preferably thermally cross-linked or chemically cross-linked or cross-linked by means of electromagnetic radiation, before the pressing-together operation. In this example, the cross-linking takes place in particular by means of UV radiation. For example, the surface relief 21 may be introduced into a moldable lacquer by means of a master structure, said lacquer then being cross-linked to obtain the structure layer 2 having the surface relief 21.

The structure layer 2 preferably comprises or consists of a thermoset. It is however also possible for the structure layer 2 to comprise or consist of an elastomer. The modulus of elasticity of the structure layer 2 is preferably greater than 3 MPa, in particular greater than 5 MPa, preferably greater than 15 MPa, and the structure layer 2 preferably has a Shore A hardness of greater than 30, in particular greater than 50, and/or a Shore D hardness of greater than 40, preferably greater than 60. A structure layer 2 having a Shore D hardness of over 60 and a modulus of elasticity of over 15 MPa is particularly preferable.

Here, by contrast, the outer layer 3 comprises or consists of, in particular, an amorphous thermoplastic. The softening temperature of the outer layer 3 preferably lies between 50 °C and 200 °C, more preferably between 80 °C and 180 °C, particularly preferably between 120 °C and 170 °C, measured in accordance with VICAT B 50.

During the pressing-together operation, a temperature is reached which lies at least 5 °C above, preferably at least 10 °C above, more preferably at least 15 °C above, the softening temperature T_{VST} of the outer layer 3. The temperature that is reached during the pressing-together operation is maintained for at least 5 minutes, in particular at least 10 minutes. During the pressing-together operation, a pressure of 0.2 MPa or more, in particular of 0.3 MPa or more, preferably of 0.5 MPa or more, more preferably of at least 1.2 MPa, is generated.

It is thus possible for the pressure and the temperature during the pressing-together operation to be adapted such that the outer layer 3 softens and the structure layer 2 is pressed into said outer layer.

Thus, as illustrated in particular by FIG. 1c, the multilayer body 1 is obtained, which has the layered entity 4 and an outer layer 3 arranged on the layered entity 4. The multilayer body also has the structure layer 2 having the surface relief 21. Here, the structure layer 2 has been pressed into the outer layer 3, or the outer layer 3 and the layered entity 4, such that the structure layer 2 is arranged fixedly in the depression 5 of the outer layer 3, or of the outer layer 3 and of the layered entity 4. The surface relief 21 of the structure layer 2 at least partially forms an exposed outer surface of the multilayer body 1. The multilayer body 1 or the layers 3 and 4 thus form a laminate comprising the structure layer 2. Preferably, therefore, the surface relief 21 has not been or is not covered by any other layer.

A thinnest point of the structure layer 2 of the multilayer body 1 has in particular a thickness of at least 1 μm or more, preferably of at least 5 μm, preferably at least 10 μm, and a thickest point of the structure layer 2 has a maximum thickness of at most 150 μm or less, in particular of at most 100 μm. In FIG. 1c, the thickness is measured in particular along a vertical.

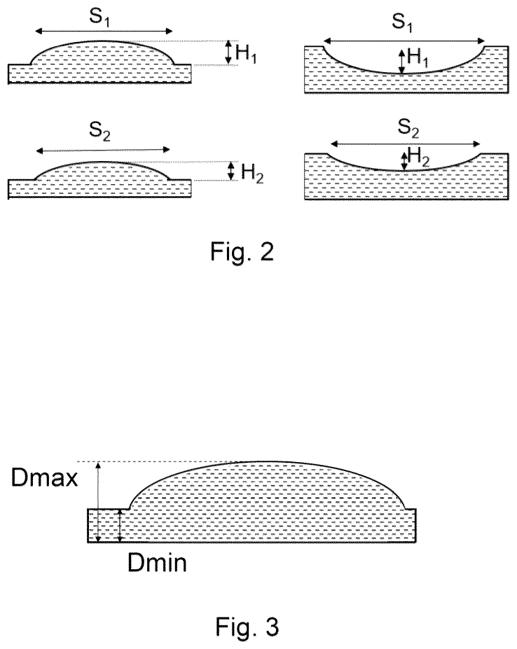

It is advantageously possible for a multilayer body 1 to thus be produced which has an HAC of greater than 0.8, in particular greater than 0.9, preferably greater than 0.95. It is furthermore possible to obtain a multilayer body 1 with an SC of greater than 0.8, in particular greater than 0.9, preferably greater than 0.95. It is advantageously also possible for the multilayer body 1 to have a structure preservation coefficient SPC of greater than 0.5, in particular greater than 0.8, preferably greater than 0.95. With regard to the determination of the HAC, the SC and the SPC, reference is made to the statements above and to the statements relating to FIGS. 2 to 4b.

It can furthermore preferably be achieved that a curvature radius of the multilayer body is greater than 0.5 m. With regard to the curvature, reference is in particular also made to FIG. 5.

It is furthermore possible the surface relief 21 of the multilayer body 1 has a maximum structure height of less than 20 μm, preferably of less than 10 μm. Such fine structure heights on an outer surface of the multilayer body are in particular only possible by virtue of the structure layer 2 being optimized for the introduction of the surface relief 21, with the rest of the outer surface being formed by the outer layer 3. Here, wear is reduced as a result of the pressing of the structure layer 2 into the depression 5, and the associated protection against abrasion.

FIG. 2 schematically illustrates the structure dimensions H1, S1, H2 and S2, which are used for determining the SPC, on the basis of one structure element of a surface relief. Said structure element is, on the left, a convex microlens and, on the right, a concave microlens. A multiplicity of such structure elements is preferably present in the surface relief, for example in a grid.

S1 and S2 indicate the diameter of the microlenses. H1 and H2 indicate the height and depth, respectively, of the microlenses. The state before the pressing-together operation, for example in the outer-layer composite or on the outer layer immediately before the pressing-together operation, is illustrated at the top in FIG. 2, and the state after the pressing-together operation is illustrated at the bottom. The pressing-together operation causes the height H2 to be decreased in relation to the height H1, and causes the diameter S2 to be increased in relation to the diameter S1. Thus, the further H2 is decreased and the further S2 is increased, the lower the SPC. The values are correspondingly categorized as follows:
SPC>0.95 very good structure preservation
SPC>0.80 good structure preservation
SPC>0.50 moderate structure preservation
SPC<0.5 normally no longer usable.

The maximum thickness Dmax and the minimum thickness Dmin of a structure element, which in this case is for example a convex microlens, are illustrated by FIG. 3. The maximum thickness Dmax of the structure layer is in particular its global maximum thickness. The maximum thickness Dmax is taken into account in particular for the HAC and the SC of the structure layer. The minimum thickness Dmin of the structure layer is in particular its global minimum thickness. If the structure layer is situated in an insert element together with one or more further layers, then it is also possible, for this purpose, for the maximum thickness Dmax and minimum thickness Dmin of the insert element to be used for determining the HAC and the SC of the insert element.

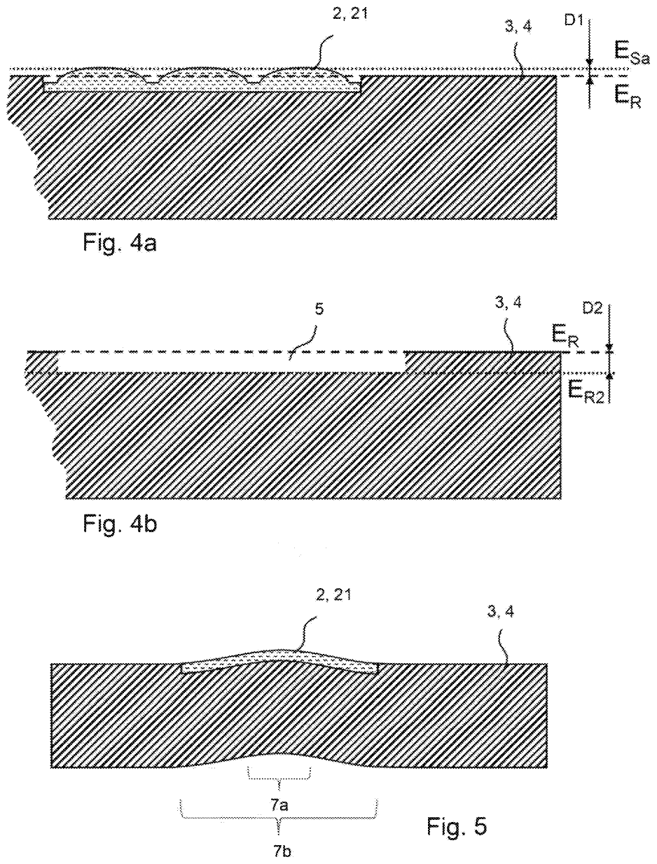

The protruding thickness D1, and the depth D2 of the depression, preferably of the depression after the structure layer or an insert element comprising the structure layer has been detached, are also required to determine the HAC and the SC. The determination of these will be illustrated by way of example on the basis of FIGS. 4a and 4b.

With regard to the protruding thickness D1, FIG. 4a illustrates the reference plane E_{R} and the outer structure layer plane E_{Sa}. The reference plane E_{R} is spanned by the outer surface of the multilayer body 1 without the depression 5, that is to say in particular by the surface outside the structure layer 2. Said surface is formed in particular by the outer layer 3. The outer structure layer plane E_{Sa} runs parallel to the reference plane E_{R} and runs through the highest points of the surface relief 21. The protruding thickness D1 can thus be determined after the pressing-together operation, in particular after the laminating operation, by measuring the distance (running vertically in FIGS. 4a and 4b) from the reference plane E_{R} to the outer structure layer plane E_{Sa}. Together with Dmax, the HAC can then be calculated:

$$H A C = \frac{D max - D 1}{D max}$$

Accordingly, what is preferred is a moderately curved multilayer body 1 having a curvature radius of >5 m outside and >0.5 m in the region having the structure layer 2 or having an insert element comprising the structure layer 2. Here, the planes can preferably be easily determined.

In particular if the multilayer body 1 has a pronounced curvature, for example in the case of a curvature radius of R<0.5 m, the SC can preferably be determined by removing the structure layer or, in the presence of an insert element having a structure layer and further layers, by removing the insert element. As a result of the removal, the curvature can commonly be reduced, and the SC can then be determined. The determination is schematically illustrated by FIG. 4b. To determine the depth D2 of the depression 5, it is possible here to measure the distance between the reference plane E_{R} and the depth reference plane E_{R2}. The depth reference plane E_{R2} contains the points on the outer surface of the multilayer body 1 in the region of the depression 5, that is to say of the structure layer 2 or of the insert element after the removal of the structure layer 2 or of an insert element comprising the structure layer 2.

Together with Dmax, the SC can then be calculated:

$$S C = \frac{D 2}{D max}$$

FIG. 5 schematically illustrates a curvature of the multilayer body 1. For the sake of simplicity, the surface relief 21 is not shown. As already discussed above, the curvature or the curvature radius may be determined in a coordinate system having an x axis and a y axis perpendicular to said x axis, wherein the multilayer body 1 extends with its length along the x axis and with its width along the y axis. For example, the multilayer body 1 illustrated by FIG. 5 has the y axis along a horizontal and has the x axis along the view directed onto the illustrated section. The curvature may be derived in particular from a surface measurement performed for example using a white light interferometer, in particular the model VK-X3000 from Keyence (company headquarters: Bedrijvenlaan 5, 2800 Mechelen, Belgium). It is preferable here for the surface profile of the rear side of the multilayer body 1 to be captured, that is to say the surface profile that is measured from below in FIG. 5. It is hereby possible in particular to determine the curvature radii Rx and Ry on the mutually perpendicular axes x and y. The curvature radius is preferably measured on the rear side because a surface relief such as the surface relief 21 makes a curvature measurement more difficult or impossible. The curvature radius is preferably measured in the center of the insert element. It is also preferable for the curvature radius to be measured over a region in which the change in the height owing to the curvature is 5 times greater, more preferably 10 times greater, than the modulation depth of surface structures or any dirt or defects. Typical sensible measurement regions extend over at least one or several mm.

The determination of the curvature radius is preferably based on a region 7a which has a dimension amounting to at most one third of the dimension, in the same direction, of the region 7b covered by the structure layer, and which contains the center of area of the latter region. The region 7a is thus preferably a portion of region 7b, and is situated at a moderate distance from the edge of region 7b (FIG. 5). More preferably, those dimensions of the region 7a along which the curvature radii are determined are preferably greater than 3 mm. The region 7a is thus in particular the aforementioned measurement region.

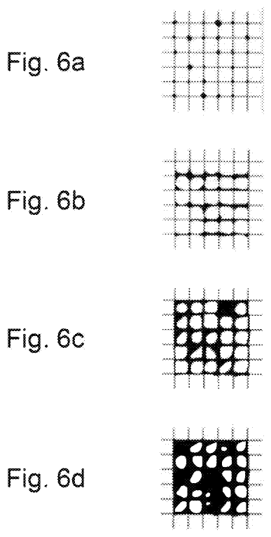

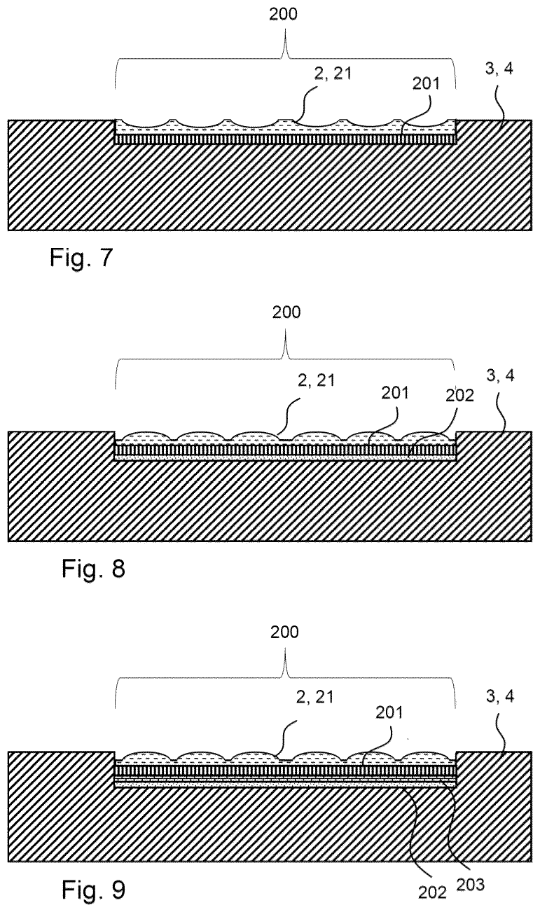

FIGS. 6a to 6d illustrate schematic results relating to the above-described cross-cut test. In this regard, reference is made to the statements made above.

Further exemplary embodiments, illustrated by FIGS. 7 to 9, will be described below. The production process and the multilayer body may be configured in particular as described with regard to FIGS. 1a to 1c, and the measurements and calculations may in particular be carried out as illustrated above and in particular on the basis of FIGS. 2 to 5.

For the examples that follow, the outer layer 3 and the layered entity 4 were provided or formed by means of the Makrofol® films specified below, from Covestro AG headquartered in Leverkusen, Germany, in the stated sequence:

| Layer | Film name | Surface | Thickness (μm) |
|---|---|---|---|
| a | Makrofol ® ID 6-2-000000 | 6/2 | 100 |
| b | Makrofol ® ID 6-2-000000 | 2/6 | 100 |
| c | Makrofol ® ID 6-4-010207 | 4/6 | 150 |
| d | Makrofol ® ID 6-4-010207 | 6/4 | 150 |
| e | Makrofol ® ID 6-4-010207 | 6/4 | 150 |
| f | Makrofol ® ID 6-2-000000 | 6/2 | 100 |
| g | Makrofol ® ID 6-2-000000 | 2/6 | 100 |

In the “Surface” column, the two values denote the surface condition, wherein, in particular, 2 indicates a very finely matted surface, 4 indicates a finely matted surface, and 6 indicates a finely structured surface. The first value relates to the upwardly pointing surface, and the second value relates to the downwardly pointing surface.

The layer a represents in particular the outer layer 3, and the layers b to g represent in particular the layered entity 4. These layers are laminated together with the structure layer 2 and its surface relief 21, preferably by means of a laminating press, for example the model SLAM 100 from Robert Bürkle GmbH headquartered in Freudenstadt, Germany, using a predefined laminating program, with the following steps being carried out in a heat press:

| | Starting | | | |
|---|---|---|---|---|
| | pressure | | | |
| | or holding | Final | | |
| | pressure | pressure | Temperature | Duration |
| Step | [MPa] | [MPa] | [°C]* | [min] |
| ST1 | 0 or <0.005 | | 170 | 4 |
| ST12 | 0 or <0.005 | 0.15 | 170 | 0.05 or <0.05 |
| ST2 | 0.15 | — | 170 | 0.05 or <0.05 |
| ST23 | 0.15 | 0.5 | 170 | 1 |
| ST3 | 0.5 | — | 170 | 1 |
| ST34 | 0.5 | 0.8 | 170 | 2 |
| ST4 | 0.8 | — | 170 | 3 |
| ST45 | 0.8 | 1.2 | 170 | 2 |
| ST5 | 1.2 | — | 170 | 4 |

*Nominal temperature of the pressing blocks

In a cold press (that is to say in particular between two pressing blocks at room temperature), the following step may for example be carried out:

| | Holding | Final | | |
|---|---|---|---|---|
| | pressure | pressure | Temperature | Duration |
| Step | [MPa] | [MPa] | [°C]* | [min] |
| ST6 | 0.14 | — | <50 °C | 5 |

The steps ST1 to ST5 in the heat press and the step ST6 in the cold press are used in particular for the pressing-together of the first to fifth examples, described below, and of the seventh to tenth examples.

The following table A shows properties of the first to tenth examples, which will be discussed in more detail further below. In table A, “SR” stands for the type of surface relief used, “IE” stands for the insert element, and “SL” stands for the structure layer, such that Dmax and Dmin are each stated for the insert element and for the structure layer.

TABLE A

| | | | Dmax | Dmin | Dmax | Dmin | | | | |
|---|---|---|---|---|---|---|---|---|---|---|
| Example | | Buffer | (IE) | (IE) | (SL) | (SL) | Rx/Ry | | | |
| no. | SR | layer | [μm] | [μm] | [μm] | [μm] | [m] | HAC | SPC | Adhesion |
| 1 | Microlens | PET 15 | >28 | >15 | >13 | >0 | 0.90/0.98 | >0.96 | 0.96 | GT 3 |
| | concave | μm | | | | | | | | |
| 2 | Microlens | PET 15 | >28 | >15 | >13 | >0 | 0.98/1.09 | >0.95 | 0.97 | GT 0 |
| | concave | μm | | | | | | | | |
| 3 | Microlens | PC 50 | 100-120 | 87-107 | 50-70 | 37-57 | 3.6/>4 | >0.98 | 0.94 | GT 0 |
| | concave | μm | | | | | | | | |
| 4 | Microlens | PC 50 | 80-100 | 67-87 | 30-50 | 17-37 | >4/>4 | >0.97 | 0.99 | GT 2 |
| | concave | μm | | | | | | | | |
| 5 | Microlens | PET 15 | 35-40 | 30-35 | 20-25 | 15-20 | 1.32/0.99 | >0.95 | 0.47 | GT 5 |
| | convex | μm | | | | | | | | |
| 6 | Microlens | PC 50 | >70-100 | >60-90 | 20-50 | 10-40 | >4/>4 | >0.97 | 0.99 | GT 4 |
| | concave | μm | | | | | | | | |
| 7 | Microlens | none | 50 | 35 | 50 | 35 | >4/>4 | >0.98 | <0.01 | GT 0 |
| | concave | | | | | | | | | |
| 8 | Microlens | PET 19 | 40 | 26 | 17 | 3 | 0.96/1.00 | >0.96 | 0.90 | GT 2 |
| | convex | μm | | | | | | | | |
| 9 | Microlens | PET 19 | 35 | 26 | 12 | 3 | 0.82/1.51 | >1 | >0.97 | GT 3 |
| | convex | μm | | | | | | | | |
| 10 | Microlens | PET 19 | 35 | 26 | 12 | 3 | 0.86/1.22 | >1 | >0.97 | GT 1 |
| | convex | μm | | | | | | | | |

A first example of a method for producing a multilayer body 1 will be described below. A multilayer body 1 that can be obtained by said method is schematically illustrated by FIG. 7. In this regard, table A summarizes some properties relating to example no. 1.

Firstly, to produce the multilayer body 1, an insert element 200 having the structure layer 2 and having a buffer layer 201, which in this first example is a PET film, is provided. Said insert element is then applied to the outer layer 3 and the layered entity 4, and the pressing-together operation is then performed in order to laminate these layers to form the multilayer body 1. As already described above, the layer a is in this case the outer layer 3, and the layered entity 4 is formed or provided by the layers b to g.

For this purpose, the insert element 200 is produced in advance, as follows:

To form the structure layer 2, a UV lacquer, that is to say a lacquer cross-linkable or cross-linked by means of UV radiation, is provided. For this purpose, use may be made of the UV lacquer of the type Norland Adhesives NOA 63 from Norland Products Inc. headquartered in Jamesburg, USA, that is to say in particular a thermoset. This is a urethane-based adhesive with a viscosity of 2000 mPa·s prior to cross-linking. The PET film is also provided in order to form the buffer layer 201. This is in particular a PET film which has been furnished with a primer on both sides and has a layer thickness of 15 μm. The use of the PET film allows subsequent better adhesion of the structure layer 2 to the outer layer 3, because the PET film, in particular in combination with the adhesion promoter layers on both sides, adheres better to the outer layer 3, that is to say in this case to the layer a, than the obtained structure layer 2.

The UV lacquer is applied to the PET film, in particular by application in droplet form, and is then cross-linked by means of a UV radiation dose of approximately 1 J/cm² whilst a master structure for shaping the surface relief 21 of the structure layer 2 is pressed onto the UV lacquer. Thus, in this example, a periodic arrangement of convex microlenses is formed as a surface relief 21. The master structure is then removed from the cross-linked UV lacquer, such that the UV lacquer has then been surface-structured with the negative structure of the master structure and forms the structure layer 2 having the surface relief 21. Cross-linking of the structure layer 2 is subsequently performed once again with approximately 0.3 J/cm².

The insert element 200 is punched out, with a circular area of 17 mm diameter, from the layer composite thus obtained. The insert element 200 is then placed onto the outer surface of the outermost layer of a PC stack, namely onto the outer layer 3, which is the layer a of the stack of layers a to g. The surface structure 21 of the structure layer 2 thus points outward. The described pressing-together operation then takes place in order to laminate said layers to form the multilayer body 1.

The multilayer body 1 thus obtained, which is in the form of a laminate, is then provided, on a front side, with a region having the exposed surface relief 21 of the insert element 200. For example, a card having dimensions of 85×54 mm² (ID-1) is punched out of the laminate. In a plan view, the multilayer body 1 thus preferably has a rectangular shape with rounded corners.

The surface of the multilayer body 1 can then be measured in the center of the insert element 200, but on the rear surface (situated opposite the front side), by means of white light interferometry. Here, it is possible for the curvature radius along each of two mutually perpendicular sections to be determined, with Rx being measured along the longer edge and Ry being measured along the shorter edge of the multilayer body. Here, the curvature radius Rx is approximately 0.90 m, and the curvature radius Ry is approximately 0.98 m.

The surface relief 21 of the structure layer 2 may be measured for example by means of confocal laser scanning microscopy (CLSM) before and after the pressing-together operation or the lamination. For this purpose, typical values (in particular average values in the case of mutually different values) for the height and the diameter of the concave microlenses can be determined, wherein, for the average values, the mean value may be calculated from in each case 3 to 4 measurements at different lenses. For example, H1 is determined over the average height before the pressing-together operation, S1 is determined over the average diameter before the pressing-together operation, H2 is determined over the average height after the pressing-together operation, and S2 is determined over the average diameter after the pressing-together operation.

This yields the following values:
H1=13.7 μm, S1=64.4 μm, H2=13.0 μm, S2=63.5 μm.

S1 and S2 are determined here in particular from the diameters of the particular lens at 95% of the height, as has in particular already been discussed above for concave lenses.

This yields a structure preservation coefficient SPC of 0.96.

$$( S P C = \frac{H 2 S 1}{H 1 S 2} )$$

CLSM was also used to measure a transition region on the surface of the multilayer body 1 in a region with and without the insert element 200. It is thus possible to determine an outer structure layer plane which runs through the highest points of the structure layer 2. The highest points of the structure layer 2 are in this case for example the intermediate spaces between the concave microlenses. Furthermore, in the region without the insert element 200, it is possible to determine a reference plane which runs through the surface of the outer layer 3, as described in particular with regard to FIGS. 4a and 4b. The measurement yielded a height difference D1<1 μm between the two planes. The thickness Dmax of the insert element was at least 28 μm (15 μm PET film plus at least 13 μm structure layer). This yielded an HAC>0.96.

It can thus be established that the insert element 200 exhibits good adhesion in the multilayer body 1. Even intense bending or attempts to remove the insert element 200 using a sharp object do not lead to detachment over a large area.

The following table lists some material parameters of Norland Adhesives NOA 63 in the cross-linked state, that is to say in particular of the structure layer 2:

| Polymer class | Thermoset |
|---|---|
| Refractive index | 1.56 |
| Modulus of | 1650 MPa |
| elasticity | |
| Shore D hardness | 90 |

To produce an outer-layer composite, it is also possible firstly for the layer a having the insert element or having a multiplicity of insert elements, of which one or more insert elements are assigned to in each case one blank, to be fastened, for example adhesively bonded, to the layer a. This outer-layer composite may then for example firstly, having been rolled up into a roll or in sheet form, be stored and/or transported before the outer-layer composite is laminated correspondingly to the above arrangement, having the layers a to g, by means of the method described in relation thereto.

In a second example, with which a multilayer body 1 schematically illustrated by FIG. 7 can be obtained, a UV lacquer of the type Lumogen® OVD Varnish 321 from BASF SE headquartered in Ludwigshafen am Rhein, Germany, that is to say in particular a thermoset, is used for the structure layer 2. As described above, the surface relief is generated with the aid of a master structure, and, for the lamination of the outer layer 3 and of the layered entity 4, is pressed together with these. The UV lacquer Lumogen® OVD Varnish 321 also falls within the polymer class of thermosets. This UV lacquer is an acrylic lacquer mixture with a viscosity of 75 mPa·s to 120 mPa·s in the non-cross-linked state.

The measured values can be determined analogously to the first example. Table A summarizes some properties relating to example no. 2.

With values Rx=0.98 m and Ry=1.09 m, the curvature radii on the rear side are similar to the first example. The structure dimensions before and after the lamination were as follows:
H1=13.9 μm, S1=64.2 μm, H2=13.3 μm, S2=63.3 μm.

This yielded an SPC of 0.97.

The measurement for the HAC of the insert element 200 yielded D1<1 μm. The thickness Dmax of the insert element 200 was at least 28 μm (15 μm of the PET film plus at least 13 μm of the structure layer 2). A maximum value for D1 and a minimum value for the thickness Dmax were used here for the calculation of the HAC of the insert element 200; this yielded HAC>0.96.

The adhesion of the insert element in the laminate can be assessed as being good. Even intense bending or attempts to remove the element using a sharp object do not lead to detachment over a large area.

In a third example, with which a multilayer body 1 schematically illustrated by FIG. 7 can be obtained, a UV lacquer of the type Norland Adhesives NOA 68 from Norland Products Inc., that is to say in particular a thermoset, is used for the structure layer 2. As described above, the surface relief 21 is generated with the aid of a master structure, and, for the lamination of the outer layer 3 and of the layered entity 4, is pressed together with these. NOA 68 is a urethane-based adhesive with a viscosity of 4500 mPa·s to 5500 mPa·s in the non-cross-linked state. By contrast to the first example, this UV lacquer is however applied not to a buffer layer 201 which is a PET film but to a buffer layer 201 which is a PC film. This PC film is in particular of the type Makrofol® ID 6-2, with a thickness of 50 μm. Here, the UV lacquer is applied to the relatively smooth side of the PC film, and is then initially structured using a master structure. Otherwise, analogously to the first example, an insert element 200 having a diameter of 17 mm is punched out and is laminated together with the outer layer 3 and the layered entity 4, which in particular form the PC stack having the layers a to g.

The structure layer thus formed exhibits sufficiently good adhesion to the PC film, wherein reliable molding of the surface relief whilst achieving adequate adhesion of the structure layer to the PC film is possible. This demonstrates in particular, expediently in comparison with the first and the second example, that a PET film as a buffer layer 201 between the structure layer 2 and the outer layer 3 is optional, and adequate adhesion of the structure layer 2 can also be achieved on a PC film.

Measured values can be determined analogously to the first example. In this regard, table A summarizes some properties relating to example no. 3.

With values Rx=3.6 m and Ry>4 m, the curvature radii on the rear side are significantly smaller than in the first example.

The structure dimensions before and after the lamination are as follows:
H1=13.4 μm, S1=64.9 μm, H2=12.8 μm, S2=66.0 μm.

This yielded an SPC of 0.94.

In addition to the values of the first example, the maximum thickness Dmax of the structure layer 2 was determined. Values of between 50 μm and 70 μm were determined. The maximum thickness Dmax of the insert element 200 (buffer layer 201 in the form of the PC film with a thickness of 50 μm plus the structure layer 2 in the range from 50 μm to 70 μm) was thus between 100 μm and 120 μm.

The protruding thickness D1 between the outer reference plane and the outer structure layer plane was <2 μm, thus yielding HAC>0.98 for the insert element 200.

The following table lists material parameters of NOA 68, that is to say of the structure layer 2, in the cross-linked state:

| Polymer class | Thermoset |
|---|---|
| Refractive index | 1.54 |
| Modulus of | 138 MPa |
| elasticity | |
| Shore D hardness | 60 |

In this third example, the structure layer was firstly applied to the aforementioned PC film that forms the buffer layer 201, then the surface relief 21 was produced, and then an insert element 200 having the structure layer 2 together with the surface relief 21 and the PC film 201 was punched out, and said insert element was subsequently pressed together and laminated with the outer layer 3 and the layered entity 4. It is however alternatively also possible for the UV lacquer NOA 68 to be applied directly over a partial area to the outer layer 3 which, like the then redundant buffer layer 201 of the third example, is a PC film, and for the surface relief 21 to be molded onto said outer layer before the pressing-together operation.

To obtain a more uniform thickness Dmax of the structure layer 2, it is also possible to seek a more uniform distribution of the UV lacquer during the application thereof and/or a more homogeneous distribution of pressure on the UV lacquer during the cross-linking of the UV lacquer.

In a fourth example, with which a multilayer body 1 schematically illustrated by FIG. 7 can be obtained, a UV lacquer of the type Norland Adhesives NOA 72 from Norland Products Inc., that is to say in particular a thermoset, is used for the structure layer 2. NOA 72 is a urethane-based adhesive with a viscosity of 155 mPa·s in the non-cross-linked state. The multilayer body 1 is produced as described with regard to the first example. By contrast to the first example, the insert element 200 is however punched out with an area of approximately 22×13 mm² and laminated together with the outer layer 3 and the layered entity 4, which in particular form the PC stack having the layers a to g.

The measured values can be determined analogously to the first and third examples. In this regard, table A summarizes some properties relating to example no. 4.

With values Rx>4 m and Ry>4 m, the curvature radii on the rear side are similar to the third example.

The structure dimensions before and after the lamination were as follows:
H1=13.4 μm, S1=64.8 μm, H2=13.3 μm, S2=63.8 μm.

This yielded an SPC of 0.99.

The maximum thickness Dmax of the structure layer 2 can be determined as described with regard to the third example. Values of between 30 μm and 50 μm can be determined. The maximum thickness Dmax of the insert element 200 (PC film as the buffer layer 201 with a layer thickness of 50 μm plus the structure layer 2 with a thickness in the range from 30 μm to 50 μm) was thus between 80 μm and 100 μm. The protruding thickness D1 between the outer reference plane and the outer structure layer plane is <2 μm, thus yielding HAC>0.97 for the insert element 200.

The following table lists material parameters of NOA 72, that is to say in particular of the structure layer 2, in the cross-linked state:

| Polymer class | Thermoset |
|---|---|
| Refractive index | 1.56 |
| Modulus of | 16.5 MPa |
| elasticity | |
| Shore D hardness | 75 |

Here, too, a more uniform application of the UV lacquer and/or a more homogeneous distribution of pressure during the cross-linking can be implemented in order to further reduce layer thickness variations.

In a fifth example, an elastomer rather than a thermoset was used for the structure layer 2. The multilayer body 1 that can be obtained is in particular also schematically illustrated by FIG. 7. This example shows that the preferred use of a thermoset for the structure layer 2 is particularly advantageous. However, even with an elastomer for the structure layer 2, it is possible in particular to achieve a high HAC.

In this fifth example, a 2-component elastomer of the type Sylgard™ 184 from The Dow Chemical Company (headquartered in Midland, Michigan, USA) is used to produce the structure layer 2. This is an addition-cross-linking silicone elastomer based on polydimethylsiloxane. After the two components are mixed, the viscosity of the mixture in the non-cross-linked state is 3500 mPa·s. The two components are mixed in the ratio of 10:1 and stirred for 15 minutes at room temperature. The mixture is applied in droplet form to a PET substrate which has been primed on both sides and which has a thickness of 15 μm, and a structure layer (master structure consisting of periodically arranged concave microlenses) applied to a PET carrier is arranged thereon and is hardened for approximately 20 minutes at 150 °C. The master structure is removed from the hardened elastomer layer, which then exhibits a surface structure having periodically arranged convex microlenses.

Analogously to the first example, the insert element 200 is punched out with an area of approximately 10×10 mm² and laminated together with the outer layer 3 and the layered entity 5, that is to say in particular the PC stack having the layers a to g.

The measured values can example be determined analogously to the first and third examples. In this regard, table A summarizes some properties relating to example no. 5.

With values Rx=1.32 m and Ry=0.99 m, the laminate curvatures on the rear side are similar to the first example.

The structure dimensions before and after the lamination were as follows: H1=12.8 μm, S1=63.7 μm, H2=6 μm to 8 μm, S2=65 μm to 68 μm. This yielded an SPC of 0.47.

Otherwise, the maximum thickness Dmax of the structure layer is determined, with values of between 20 μm and 25 μm being determined here. The maximum thickness Dmax of the insert element (buffer layer 201 in the form of the PET film with a thickness of 15 μm plus the structure layer 2 with the thickness in the range of 20 μm and 25 μm) is thus between 35 μm and 40 μm.

The measurement of D1, that is to say in particular the distance between the outer reference plane and the outer structure layer plane after the lamination, yielded that the latter was lower by 2 μm to 3 μm in the measured regions. Possible causes are pronounced material expansion at elevated temperatures, locally elevated structures, and dirt.

It is for example possible that, at a certain point in time during the lamination, the structure layer has been pressed in so as to be flush, for example in step S5, but in the presence of a temperature around or slightly below the softening temperature of the outer layer. At this point in time, the form fit of the insert element would already be present. However, during the further cooling process, the structure layer may shrink, and the structure layer plane may come to lie below the reference plane.

It is also possible that there are regions within the surface structure which contain structures taller than those in the edge region. This is possible specifically in view of the rather poor SPC. These elevated structures could then lead to subsidence to a greater depth than that observed in the edge region. The HAC of the insert element 200 therefore has a value of 1.08.

The result is therefore poor adhesion of the structure layer 2 to the buffer layer 201, which in this case is a PET film. The structure layer 2 can for example be easily removed over the full area by means of a blade.

The following table lists material parameters of Sylgard™ 184, that is to say in particular of the structure layer 2, in the cross-linked state:

| Polymer class | Elastomer |
|---|---|
| Refractive index | 1.41 |
| Modulus of | 6.7 MPa |
| elasticity | |
| Shore A hardness | 43 |

In a sixth example, with which a multilayer body 1 schematically illustrated by FIG. 7 can be obtained, the production process takes place analogously to the fourth example, aside from the fact that a maximum laminating pressure of 0.5 MPa rather than 1.2 MPa is used for the pressing-together of the layers.

For the pressing-together of the layers in the heat press, the following steps were carried out:

| | Starting | | | |
|---|---|---|---|---|
| | pressure | | | |
| | or holding | Final | | |
| | pressure | pressure | Temperature | Duration |
| Step | [MPa] | [MPa] | [°C]* | [min] |
| ST1 | 0 or <0.005 | | 170 | 4 |
| ST12 | 0 or <0.005 | 0.15 | 170 | 0.05 or <0.05 |
| ST2 | 0.15 | — | 170 | 0.05 or <0.05 |
| ST23 | 0.15 | 0.5 | 170 | 1 |
| ST3 | 0.5 | — | 170 | 12 |

*Nominal temperature of the pressing blocks

In the cold press, the following step was carried out:

| | Holding | Final | | |
|---|---|---|---|---|
| | pressure | pressure | Temperature | Duration |
| Step | [MPa] | [MPa] | [°C]* | [min] |
| ST4 | 0.14 | — | <50 °C | 5 |

The measurement results were able to be determined similarly to the previous examples. In this regard, table A summarizes some properties relating to example no. 6.

With values Rx>4 m and Ry>4 m, the curvature radii on the rear side of the multilayer body 1 are similar to the fourth example.

The structure dimensions before and after the pressing-together operation or the lamination are as follows:
H1=13.5 μm, S1=64.5 μm, H2=13.3 μm, S2=63.6 μm.

This yielded an SPC of 0.99.

The maximum structure layer thickness was at least 20 μm and at most 50 μm.

The distance between the reference plane and the outer structure layer plane was <2 μm, thus yielding HAC>0.97.

In a seventh example, with which a multilayer body 1 schematically illustrated by FIG. 7 can be obtained, the production process takes place analogously to the third example, aside from the difference that use is not made of a UV lacquer as a structure layer 2; rather, the PC film specified for the buffer layer 201 is used as structure layer 2. In other words, here, the surface relief 21 is introduced directly into the PC film, that is to say in particular into a thermoplastic structure layer. Analogously to example 3, an insert element 200 having a diameter of 17 mm was punched out and was laminated together with the outer layer 3 and the layered entity 4, which form the PC stack of the layers a to g. This example illustrates in particular the advantage of a thermoset structure layer over a thermoplastic structure layer.

The measured values can be determined analogously to the third example. In this regard, table A summarizes some properties relating to example no. 7.

With values Rx>4 m and Ry>4 m, the curvature radii on the rear side are similar to the third example.

The structure dimensions before the pressing-together operation or the lamination are as follows:
H1=13.4 μm, S1=64.1 μm.

After the lamination, the surface relief is no longer discernible and therefore cannot be measured. An SPC also cannot be calculated in this case. For the sake of continuity, however, this is stated as having a value close to zero. Alternatively, the SPC could be stated as being “not measurable”.

The protruding thickness D1 was <1 μm, yielding HAC>0.98 for the structure layer. Considering the initial thickness of the insert element 200 (in this case 50 μm of the PC film), HAC>0.98 is calculated for the insert element 200.

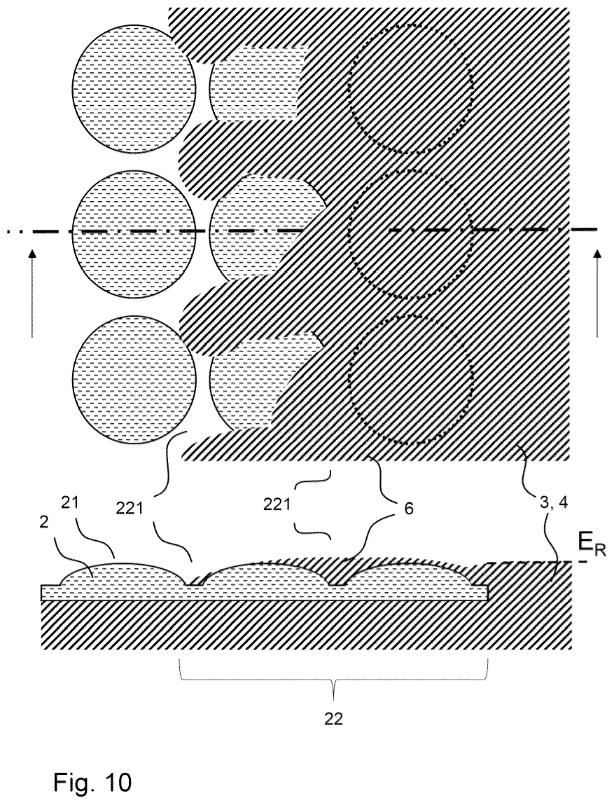

In an eighth example, with which a multilayer body 1 schematically illustrated by FIG. 8 can be obtained, an insert element 200 is provided, wherein, here, the structure layer 2 has been applied to a PET carrier film with a thickness of 19 μm, and a hot-sealing adhesive 202 is applied with a thickness of 1 μm to 2 μm to that side of the PET carrier film which is situated opposite the structure layer 2. The insert element 200 has an area of approximately 20×20 mm².

The insert element 200 is produced in a roll-to-roll process, wherein a lacquer cross-linkable by UV is applied to a PET carrier film, and a surface structure 21 is molded by means of a stamping roller and by application of UV radiation, such that a structure layer 2 is formed. As structure layer material, use is made here in particular of a thermoset. In particular, a PET auxiliary carrier film having a self-adhesive laminating adhesive with a thickness of 10 μm to 30 μm and having a release layer with a thickness of 10 nm to 50 nm is laminated onto said structure layer.

In a further step, a hot-sealing adhesive is applied with a thickness of 1 μm to 2 μm to that side of the PET carrier film which faces away from the structure layer 2, and is thermally dried. Likewise in the roll-to-roll process, an outer-layer composite body thus obtained is punched out, up to and including the structure layer 2, from the side of the PET carrier film by means of a punching tool having a defined punching die, such that the insert elements 200 are formed but remain adhered to the non-punched PET auxiliary carrier film. In particular, the outer-layer composite thus obtained can be stored as roll goods until it is processed further. In particular, in a further step, individual insert elements or a plurality of insert elements may be detached, or, in particular, in a roll-to-roll process, a plurality of insert elements may be applied by hot stamping to a PC layer that forms the outer layer 3.

In this example, the surface relief 21 consists of spherical microlenses having a height of 14.0 μm and a curvature radius of 44.5 μm before the pressing-together operation. The thickness of the structure layer 2 before the pressing-together operation is 14 μm to 17 μm at the thickest point and 1 μm to 3 μm at the thinnest point. Then, in particular analogously to the first example, the insert element 200 having an area of approximately 20×20 mm² is placed onto the outer layer 3 of the PC stack consisting of the layers a to g, and the layers are laminated by means of the pressing-together operation.

The measured values of the multilayer body 1 can be obtained as already described. In this regard, table A summarizes some properties relating to example no. 8.

The structure dimensions before the pressing-together operation or the lamination are as follows:
H1=14.0 μm, S1=63.6 μm.

The structure dimensions after the pressing-together operation or the lamination are as follows:
H2=12.7 μm, S2=63.3 μm.

This yielded an SPC of approximately 0.90.

The distance D1 between the reference plane and the outer structure layer plane was <1 μm, thus yielding HAC>0.96.

In a ninth example, with which a multilayer body 1 schematically illustrated by FIG. 9 can be obtained, the structure layer 2 or the insert element 200 is produced as in the eighth example, with the microlenses however having the following dimensions before the pressing-together operation: height: 8.6 μm, diameter: 22.4 μm, curvature radius: 11.3 μm.

The curvature radius of the lenses (11.3 μm) is selected such that that side of the PET carrier film which is situated opposite the structure layer 2 lies in the focal plane of the microlenses. A color print layer 203 is applied to this side such that, in a view directed through the microlenses, an item of image information is visible which moves with the viewing angle.

The item of image information remains visible, unchanged, after the pressing-together operation or the lamination. In other words: The relationship between the two optical elements (in this case microlenses and color print) was maintained after the lamination.

The further measured values after the pressing-together operation or the lamination are listed in table A under example no. 9.

The structure dimensions before the pressing-together operation or the lamination are as follows:
H1=8.6 μm, $1=22.4 μm.

The structure dimensions after the pressing-together operation or the lamination are as follows:
H2=8.6 μm, S2=22.5 μm.

The distance between the reference plane and the outer structure layer plane is in this case<0, that is to say the uppermost point of the microlenses lies below the reference plane. In this case, the difference was 10 μm to 15 μm. The HAC was therefore at most 1.4.

In a tenth example, with which a multilayer body 1 schematically illustrated by FIG. 9 can be obtained, the structure layer 2 or the insert element 200 is produced as in the ninth example, with the difference that the microlenses have the following dimensions before the pressing-together operation or laminating operation: height: 8.4 μm, diameter: 22.6 μm, curvature radius: 11.3 μm

As in the ninth example, the relationship between the two optical elements (microlenses and color print) was maintained after the lamination.

The measured values after the pressing-together operation or the lamination are listed in table A under example no. 10.

The structure dimensions before the pressing-together operation or the lamination are as follows:
H1=8.4 μm, S1=22.6 μm.

The structure dimensions after the pressing-together operation or the lamination are as follows:
H2=8.6 μm, S2=22.5 μm.

The distance between the reference plane and the outer structure layer plane is in this case<0, that is to say the uppermost point of the microlenses lies below the reference plane. The HAC is therefore>1.

FIG. 10 schematically illustrates an exemplary embodiment of a multilayer body 1 with form-fitting embedding of the structure layer 2 within the multilayer body 1. Here, in the edge region 22, depressions 221 of the surface relief 21 have been filled with material 6 of the multilayer body 1. Preferably, this is in particular thermoplastic material of the outer layer 3, which during the pressing-together operation softens and is pressed into the depressions 221. Alternatively or in addition, however, it is also conceivable for in particular thermoplastic material of the layered entity 4 to be pressed into the depressions 221 during the pressing-together operation. Such an edge region 22 can preferably be implemented in any one of the eighth to tenth examples.

As can be seen in FIG. 10, the surface relief 21 may have the same type of surface relief 21 in the edge region 22 as in adjacent regions. It is however also possible that, in the edge region 22, a structure is provided which differs from the rest of the surface relief 21, in particular in order to optimize the surface relief 21 in the edge region 22 for the form-fitting integration and in order to optimize the rest of the surface relief 21 for the optical effect.

FIG. 10 also illustrates how the reference plane E_{R} is preferably determined if the multilayer body 1 has different heights of the outer layer 3. For the most part, the multilayer body 1 in FIG. 10 in this case has substantially a surface with the height that is present at the right-hand edge. The reference plane E_{R} is thus preferably spanned in this case by the surface having this height. Elevations of relatively small area and similar local raised portions, which may for example be present in the edge region 22, are thus preferably disregarded for the definition of the reference plane E_{R}.

The exemplary embodiments shown are not to be understood as limiting. The specified design variants may self-evidently be combined with one another as desired. Features of the multilayer body 1 and of the outer-layer composite 30 may in particular be comprised by the method illustrated on the basis of the exemplary embodiments, and features of the method may be applied to the multilayer body 1 and to the outer-layer composite 30. Features of layers of the multilayer body 1 may furthermore be applied to features of the outer-layer composite 30, and vice versa.

### LIST OF REFERENCE SIGNS

| | |
|---|---|
| 1 | Multilayer body |
| 2 | Structure layer |
| 200 | Insert element |
| 201 | Buffer layer |
| 202 | Hot-sealing adhesive layer |
| 203 | Color print layer |
| 21 | Surface relief |
| 210 | Pressing tool |
| 211 | Pressing surface |
| 22 | Edge region |
| 221 | Depression(s) of the surface relief |
| 3 | Outer layer |
| 30 | Outer-layer composite |
| 4 | Layered entity |
| 5 | Depression |
| 6 | Material of the outer layer and/or of the layered entity |
| 7a, 7b | Regions |
| E_{R} | Reference plane |
| E_{R2} | Depth reference plane |
| E_{SA} | Outer structure layer plane |
| D1 | Protruding thickness |
| D2 | Depth of the depression |
| Dmin | Minimum thickness |
| Dmax | Maximum thickness |
| H1 | Height before the pressing-together operation |
| H2 | Height after the pressing-together operation |
| S1 | Diameter before the pressing-together operation |
| S2 | Diameter after the pressing-together operation |

1. A method for producing a multilayer body, the method comprising the following steps:
a) providing an outer layer;
b) providing a structure layer having a surface relief, wherein the surface relief forms a surface, averted from the outer layer, of the structure layer;
c) providing a layered entity comprising at least one layer;
d) pressing the structure layer, the outer layer and the layered entity together in order to laminate the structure layer, the outer layer and the layered entity, wherein the structure layer is more dimensionally stable than the outer layer, and wherein the outer layer, the structure layer and the layered entity are fixedly interconnected as a result of the pressing-together operation, and the following step takes place during the pressing-together operation:
d1) pressing the structure layer into the outer layer, or into the outer layer and the layered entity, in such a way that the structure layer forms a depression into the outer layer, or into the outer layer and the layered entity, and the structure layer is fixedly arranged in said depression, and that the surface relief of the structure layer at least partially forms an exposed outer surface of the obtained multilayer body.

2. The method according to claim 1, wherein the pressing-together operation is performed by means of a pressing tool that has a pressing surface, wherein the pressing tool is placed in direct contact with the surface relief of the structure layer during the pressing-together operation such that a force is exerted on the structure layer by means of the pressing surface, wherein the pressing surface is planar and/or at least a region of the pressing surface over which the force is exerted on the structure layer is planar.

3. The method according to claim 2, wherein the pressing surface is comprised by a pressing plate of a laminating device.

4. The method according to claim 1, wherein the structure layer comprises and/or consists of a thermoset and/or comprises and/or consists of an elastomer, and wherein the structure layer has a modulus of elasticity of greater than 3 MPa, and a Shore A hardness of greater than 30.

5. The method according to claim 1, wherein the structure layer has a thinnest point with a thickness of at least 1 μm or more, and a thickest point with a maximum thickness of at most 150 μm or less.

6. The method according to claim 1, wherein the outer layer comprises or consists of an amorphous thermoplastic.

7. The method according to claim 1, wherein the outer layer has a softening temperature of 50 °C to 200 °C.

8. The method according to claim 1, wherein, on a side facing toward the outer layer, the structure layer has been furnished with one or more of the following layers: a buffer layer, a color layer, a further structured layer, a hot-sealing adhesive layer.

9. The method according to claim 1, wherein, in the region of the structure layer or of an insert element having the structure layer, the multilayer body has only regions with a mean curvature radius of greater than 0.5 m.

10. The method according to claim 1, wherein the multilayer body has a height alignment coefficient HAC of greater than 0.8, wherein the HAC is calculated as follows:
$$H A C = \frac{D max - D 1}{D max}$$
with the maximum thickness Dmax of the structure layer after the pressing-together operation, or of an insert element having the structure layer after the pressing-together operation, and the protruding thickness D1 of the structure layer, which is spanned by the outer layer outside the depression, and an outer structure layer plane, which is spanned by maxima of the structure layer.

11. The method according to claim 1, wherein the multilayer body has a subsidence coefficient SC of greater than 0.8, wherein the SC is calculated as follows:
$$S C = \frac{D 2}{D max}$$
with the maximum thickness Dmax of the structure layer, or of an insert element having the structure layer, after the pressing-together operation, and the depth D2 of the depression.

12. The method according to claim 1, wherein the multilayer body has a structure preservation coefficient SPC of greater than 0.5, wherein the structure preservation coefficient is calculated as follows:
$$S P C = \frac{H 2 S 1}{H 1 S 2}$$
with the height H1 and the width S1 of a structure element of the surface relief, before the pressing-together operation, and the height H2 and the width S2 of a structure element of the surface relief after the pressing-together operation.

13. The method according to claim 1, wherein, during the pressing-together operation, a temperature is reached which lies at least 5 °C above the softening temperature T_{VST} of the outer layer.

14. The method according to claim 1, wherein the temperature that is reached during the pressing-together operation is maintained for at least 2 minutes.

15. The method according to claim 1, wherein, during the pressing-together operation, a pressure of 0.2 MPa or more is generated.

16. The method according to claim 1, wherein the structure layer has been or is cross-linked.

17. A multilayer body comprising:
a layered entity comprising at least one layer;
an outer layer arranged on the layered entity; and
a structure layer having a surface relief,
wherein the structure layer has been pressed into the outer layer, or the outer layer and the layered entity, in such a way that the structure layer has been fixedly arranged in a depression of the outer layer, or of the outer layer and of the layered entity, and that the surface relief of the structure layer at least partially forms an exposed outer surface of the multilayer body.

18. The multilayer body according to claim 17, wherein, in an edge region of the structure layer, the surface relief has been integrated form-fittingly into the multilayer body.

19. The multilayer body according to claim 17, wherein, in the edge region, the surface relief has one or more depressions which are at least partially filled with material of one or more layers of the multilayer body.

20. The multilayer body according to claim 17, wherein, in the edge region, the surface relief has a structure which differs from the rest of the surface relief.

21. The multilayer body according to claim 17, wherein the surface relief has a maximum structure height of less than 20 μm.

22. An outer-layer composite for producing a multilayer body, wherein the outer-layer composite has an outer layer and a structure layer, wherein the structure layer has a surface relief on a side averted from the outer layer and is more dimensionally stable than the outer layer such that the outer layer can be laminated together with a layered entity to form the multilayer body, wherein the structure layer can be pressed into the outer layer such that the structure layer can be arranged in a depression of the outer layer and an exposed outer surface of the multilayer body can be at least partially formed by the surface relief.

23. The outer-layer composite according to claim 22, wherein the outer layer and the structure layer are configured such that the structure layer can be pressed into the outer layer by a pressure exerted on the structure layer in the direction of the outer layer.

24. The outer-layer composite according to claim 22, wherein the outer layer has a layer thickness which at least corresponds to or is greater than the layer thickness of the structure layer.

25. The outer-layer composite according to claim 22, wherein the outer layer has been furnished with at least one adhesion promoter layer on a side facing toward or averted from the structure layer, or on each of two opposite sides.
